(19) United States
(12) Patent Application Publication
(10) Pub. No.: US 2008/0295728 A1
(43) Pub. Date: Dec. 4, 2008

(54) COATINGS INCLUDING TOBACCO PRODUCTS AS CORROSION INHIBITORS

(75) Inventor: Joseph A. von Fraunhofer, Parkton, MD (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Inhibitrol Inc., Parkton, MD (US)

(21) Appl. No.: 12/130,669

(22) Filed: May 30, 2008

Related U.S. Application Data
(60) Provisional application No. 60/940,743, filed on May 30, 2007.

(51) Int. Cl. C09D 5/08

(52) U.S. Cl. 106/14.42; 106/14.05

(57) ABSTRACT

The invention relates to coatings, such as paints, containing tobacco products and the use thereof as corrosion inhibitors. The tobacco products include various forms of tobacco such as dried tobacco leaves, stems, dust, liquid extracts, etc, that can be added to the coatings. The invention further relates to treatment methods and compositions for surface treatments such as descaling, pickling and removing surface deposits and corrosion products.

### CROSS REFERENCE TO RELATED APPLICATIONS

This application claims priority under 35 U.S.C. § 119 to U.S. Provisional Patent Application No. 60/940,743, filed May 30, 2007, which application is expressly incorporated herein by reference in its entirety.

### BACKGROUND OF THE INVENTION

1. Field of the Invention

The invention relates to coatings, such as paints, containing tobacco products and the use thereof as corrosion inhibitors. The tobacco products include various forms of tobacco such as dried tobacco leaves, stems, dust, liquid extracts, etc, that can be added to the coatings. The invention further relates to treatment methods and compositions for surface treatments such as descaling, pickling and removing surface deposits and corrosion products.

2. Related Art

The simplest and most widely used protective system for metals against corrosion is painting and a very wide variety of protective paints are available to industry. For many years the commonly used protective paints were based on alkyd, vinyl, epoxy, polyurethane, chlorinated rubber and various other resins dispersed in organic solvents, such systems being commonly referred to as “oil paints.” In order for paints to provide corrosion protection, they must incorporate corrosion inhibiting pigments. The inhibitive pigments that were used for the bulk of the 20^{th} century and earlier included metallic lead, red lead and various other lead salts, metallic zinc and a variety of chromates. The selection of paint type and inhibitive pigment was dictated by cost, ease of application and the anticipated service environment. These paints systems were highly effective although their use presented many environmental and personnel problems.

In recent years, environmental and toxicological considerations have resulted in changes in paint technology. In particular, there is now greater use of paints with lower levels of volatile organics, high solids paints as well as water-based (“latex”) paints and a major shift away from the traditional lead-based and chromate pigments. In fact, lead incorporation in paints is banned in most countries and the use of chromates will shortly follow the same trend. There is, therefore, a very real need for a low cost, high efficacy, environmentally safe and non-toxic pigment that can be readily incorporated into a wide variety of paint systems.

Acid pickling is routinely used in virtually all aspects of the metallurgical and finishing industries to remove corrosion products and mill scale from the metal surface. Unfortunately, the surface coverage of the metal by corrosion products is uneven so that, for steel, as the acid dissolves away mill scale, rust and oxides, it will attack the bare metal as well as the residual rust. This acid attack often mars or pits the surface and, accordingly, the acid must contain an inhibitor to reduce attack on the bare (rust-free) metal.

Pickling is used for virtually all metals and alloys prior to any subsequent processing and surface finishing such as electroplating, galvanizing and painting as well as fabrication into metal structures and components.

Additionally, scale build-up over time occurs in every water-cooled/heated piece of equipment on Navy ships as well as both Military and civilian ground-based installations. In situations where hard water is used, the build-up can be rapid. The result is decreased efficiencies due to the reduced heat transfer. Hard scale deposits, typically calcium carbonate, silicate, calcium hydrate, calcium sulfate, and iron oxide, inside heat exchanger tubes, piping systems, and water-operated machinery are difficult to remove. Typical remedies include high pressure hydroblasting or removing the equipment and cleaning with hazardous acids or other dangerous chemicals. However, these approaches have safety and operational concerns and are not always available onboard a ship.

There is therefore also a need for a family of descaling chemicals that are effective yet are environmentally and personnel safe. They should be skin safe (i.e., skin protection is not required), capable of disposal down regular sewer systems with a fresh water flush, compatible with metals found in shipboard water-cooled/heated systems (i.e., corrosion of the metals is not induced during the descaling operation), emit no hazardous vapors during descaling, and usable at room temperature.

### SUMMARY OF THE INVENTION

The invention relates to coatings, such as paints, containing tobacco products (Envirosafe™) and the use thereof as corrosion inhibitors. The tobacco products include various forms of tobacco such as dried tobacco leaves, stems, dust, liquid extracts, etc, that can be added to the coatings.

The invention further relates to treatment methods and compositions for surface treatments such as descaling, pickling and removing surface deposits and corrosion products (described above). The invention includes the preparation and use of combinations of a relatively weak organic acid(s) with tobacco infused products that are very effective, safe and environmentally benign. These organic acids are known to be effective in removing scale. Likewise, dilute mineral acids may be used for descaling. One problem with these acids used for descaling is that they tend to promote corrosion of metal pipes and structures, especially when dissimilar metals are coupled together. Although most corrosion inhibitors are toxic (e.g., chromates) and cannot be disposed of normally or are less effective, extracts from tobacco are environmentally benign, biodegradable and are very effective as corrosion inhibitors. The corrosion inhibition by the inventive tobacco infused products of the invention is because the source plant material itself is an effective producer of complex organic chemicals which inhibit corrosion.

A series of studies were performed under the aegis of USAF SBIR Program FA8650-07-M-5031. The objective of this program was to develop non-chromate inhibitive pigments for conductive paint systems. Among other things, the corrosion inhibitive effectiveness of tobacco for 2024 aluminum alone and when coupled to silver in 3.5% NaCl solution was evaluated. Weight loss (immersion studies) and galvanic coupling studies were undertaken with bare aluminum and aluminum coupled to silver. Electrochemical (EIS) studies and salt fog tests were performed on coated 2024 aluminum specimens. Key results of the program were:

1. Tobacco is more effective than chromate at protecting 2024 aluminum alloy in 3.5% NaCl solution

2. Tobacco reduces corrosion in the galvanic aluminum-silver couple immersed in 3.5% NaCl solution

3. Tobacco dust and aqueous extracts are highly effective corrosion inhibitive pigments in coatings.

The studies on bare aluminum clearly demonstrated that tobacco dust and extract were highly effective in reducing the corrosion in 3.5% NaCl solution of aluminum alone and when coupled to silver. Inhibition rates of 95% were found for approximately 0.1% by weight tobacco extract additions and 96.6% for approximately 1.0% by weight additions over 55 days. It was also noted that while aluminum in salt solution showed marked accretion of salt deposits, no such deposition of salt occurred in the tobacco-containing solutions. EIS and salt-fog chamber studies were performed on the recommended MIL-specification primer, Deft 44GN098 Chrome-free water reducible epoxy primer applied to 2024 aluminum as the test substrate. The primer supplied by the manufacturer, ostensibly manufactured without corrosion inhibitors present in the formulation, in fact appeared to contain inhibitors. This conclusion was reached after all data were analyzed. As a result, while the data presented here indicate the high effectiveness of tobacco as a corrosion inhibitor, test data might be even more impressive if an inhibitor-free primer had been supplied for the test program.

Additions of both tobacco dust and aqueous tobacco extract were made to the primer. It was noted that dust additions above 5 wt. % increased the mixed coating viscosity so that surface coating was difficult at high loadings. Further, because the tobacco dust particle size range was not optimized, many coatings showed evidence of holiday formation. Nevertheless, despite these disadvantages, the dust-containing coated specifications exhibited excellent performance and, despite the presence of defects within the coating, there was no evidence of substrate attack in salt fog testing or in EIS studies. Further, it was noted that for both tobacco dust and liquid extract additions to the test primer, there appeared to be no detrimental effects on coating adhesion to the substrate.

Salt fog chamber data indicate that additions of tobacco dust and liquid tobacco extracts provided excellent corrosion protection to the 2024 substrate and, further, had no deleterious effects on the stability of the coating. It was concluded that tobacco dust additions should be limited to approximately 5 wt. % and liquid extract additions to 10 wt. % to ensure optimum coating performance when Deft 44GN098 Chrome-free water reducible epoxy primer (as supplied) is used as the primer. Different addition levels are clearly possible in coatings formulated without inhibitive pigments.

These results show that in coatings that perform well; tobacco additions to the coating provided excellent corrosion inhibition over a 3 month test period. In cases where the coatings contained defects, and so can be expected to fail in a relatively short test period, the tobacco additive (particulate dust in this study) appeared to slow the corrosion damage to the substrate. The findings suggest that even when defects are present in the coating and allow the rapid ingress of moisture to the coating/substrate interface, the presence of solid tobacco particles in the coating plays a role in slowing the corrosion rate overall and possibly also blocks particular reactions all together.

The findings of this study indicate that tobacco additions to primer coatings, both as dust and as liquid tobacco extracts, provide corrosion protection to the 2024 substrate. Further, there are indications that the presence of tobacco may change the nature of the corrosion reactions. Pilot potentiostatic polarization studies indicate that both the cathodic and the anodic reactions are polarized by the presence of tobacco in solution. These reaction polarization effects result in a shift of the corrosion potential to more noble values and reduced cathodic and anodic current densities compared to bare aluminum in 3.5% NaCl.

Overall, this study demonstrates the effectiveness of tobacco in inhibiting the corrosion of 2024 aluminum alone and when coupled to silver, the latter situation being found with conductive coatings.

Additionally, while tobacco in its various forms (e.g., leaf, dust, extracts, etc.) is a highly effective corrosion inhibitor for latex and oil paints and for pickling acids and both acidic and alkaline cleaning media, it can also be combined with other inorganic (e.g., chromates, nitrites, phosphates and silicates), metallic and metal oxide, and organic (e.g., benzoates, amines) pigments to take advantage of synergistic effects when two or more inhibitive pigments are combined into a formulation. Further, by combining two or more inhibitive pigments into a formulation, it is further possible to take advantage of changes in the addition level requirements in paint formulations, particularly when synergistic effects are present. Among other things, for example, tobacco additions markedly improved the corrosion inhibition of steel rebar by the standard concrete additive DCI, and is a good example of inhibition synergistic effects

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates coated specimens containing tobacco dust after neutral salt fog exposure;

FIG. 2 illustrates 2024 aluminum panels immersed in 3.5% NaCl and 3.5% NaCl solution containing 1.56% KY burley extract for 55 days;

FIG. 3 illustrates weight loss (mean values ±standard deviations, mg/cm²) of 2024 aluminum in 3.5% NaCl and 3.5% NaCl+1.56% tobacco extract;

FIG. 4 illustrates the appearance of 2024 aluminum after exposure to 3.5% NaCl (top) and 3.5% NaCl containing 1.56% tobacco extract (bottom) for 110 days;

FIG. 5 illustrates weight loss (after ultrasonic cleaning) of 2024 aluminum after exposure to 3.5% NaCl and 3.5% NaCl containing 1.56% tobacco extract for 110 days;

FIG. 6 illustrates uncoated specimens of 2024 T3 Aluminum before (left) and after 500 hrs of salt-fog cycles;

FIG. 7 illustrates pure polyamide primer before (left) and after (right) salt fog treatment;

FIG. 8 illustrates primer coating with 1 wt % loading of tobacco dust before (left) and after (right) salt fog cycles for 500 hrs;

FIG. 9 illustrates the Al test specimens with primer containing tobacco dust at 5 wt % loading before and after corrosion testing;

FIG. 10 illustrates liquid tobacco extract added at 1% by weight to primer mixture pre- and post-salt fog cycles;

FIG. 11 illustrates liquid tobacco extract added at 5 wt % loading pre- and post-salt fog cycles;

FIG. 12 illustrates specimens of 2024 aluminum coated with primer containing liquid tobacco extract addition after salt fog testing;

FIG. 13 illustrates coated 2024 Al specimens with high loading (1:1 by volume): Left: Specimen before salt fog testing Middle: Specimen after salt fog testing showing flaking of the coating Right: Portion of coating removed to show absence of substrate corrosion;

FIG. 14 illustrates the impedance values associated with three different measurement frequencies are plotted versus exposure time. FIG. 14A—1 MHz, FIG. 14B—100 Hz, and FIG. 14C—0.1 Hz. Recall that X1 and W1 are the intact extract and control coatings, respectively, and the others are the specimens with intentional scribes;

FIG. 15 illustrates Left: The blistered DEFT coating specimen shown after the tape-pull test. Right: The main blister locations were characterized by widespread pitting of the aluminum substrate, dissolution and redeposition of copper, and formation of large crystalline particles (aluminum oxides and hydroxides);

FIG. 16 illustrates Left: A DEFT+tobacco dust coating specimen shown after the tape-pull test. The tape is shown above the panel, with only three small paint chips pulled from the panel. Right: The substrate below the coating break was dulled and the edges of the coating were lifting slightly. The area pulled off by the tape was only a few mm²;

FIG. 17 illustrates the corrosion inhibitive efficacy of the tobacco infused products of the invention (applied on left) on the substrate steel during intermittent salt spray exposure over 24 hours;

FIG. 18 illustrates the effect of the tobacco infused products of the invention (dust) addition on corrosion protection paints; (FIG. 18A) latex paint without (left) and 0.3% of the tobacco infused products of the invention (right) after salt spray testing; (FIG. 18B) oil paint with 0.3% of the tobacco infused products of the invention dust (left) and without addition (right);

FIG. 19 illustrates Left: The same DEFT+tobacco dust coating specimen presented in FIG. 15 is shown here with additional area exposed by using a tweezers to wedge between the coating and substrate and lift the coating away. Right: A closer view near the center of the substrate surface. There was activity at the substrate/coating interface, however no severe pitting or heavy copper dissolution/re-deposition was found;

FIG. 20 illustrates polarization behavior of aluminum in NaCl solution containing 2.1% of the tobacco infused products of the invention;

FIG. 21 illustrates corrosion rate of aluminum in salt solution containing dichromate and the tobacco infused products of the invention additions;

FIG. 22 illustrates galvanic corrosion currents for the Al-steel couple in salt water with chromates and the tobacco infused products of the invention;

FIG. 23 illustrates relative corrosion rates for the steel-aluminum couple in salt solution;

FIG. 24 illustrates mild steel rods after immersion in 10% sulfuric acid solution for 30 minutes (left: acid with tobacco; right: untreated acid);

FIG. 25 illustrates hard scale deposits;

FIG. 26 illustrates attack on steel by 10% sulfuric acid with and without the tobacco infused products of the invention over 20 minutes;

FIG. 27 illustrates weight loss of steel in 10% sulfuric acid with and without the tobacco infused products of the invention;

FIG. 28 illustrates weight loss of steel in 11% hydrochloric acid solution and with complete dissolution of steel in untreated acid;

FIG. 29 illustrates dissolution of aluminum in 5% sodium hydroxide (NaOH) solution with complete dissolution in unprotected alkali solution; and

FIG. 30 illustrates the effect of different levels of the tobacco infused products of the invention on aluminum dissolution in 5% NaOH solution over 1.5 hours.

### DETAILED DESCRIPTION OF THE INVENTION

The invention relates to coatings, such as paints, containing tobacco products and the use thereof as corrosion inhibitors. The tobacco products include various forms of tobacco such as dried tobacco leaves, stems, dust, liquid extracts, etc, that can be added to the coatings. To this end, a series of studies were performed establishing the corrosion inhibitive effectiveness of tobacco for 2024 aluminum alone and when coupled to silver in 3.5% NaCl solution was evaluated. Weight loss (immersion studies) and galvanic coupling studies were undertaken with bare aluminum and aluminum coupled to silver. Electrochemical (EIS) studies and salt fog tests were performed on coated 2024 aluminum specimens. These analyses, as described below, establish, among other things, that (i) tobacco is more effective than chromate at protecting 2024 aluminum alloy in 3.5% NaCl solution, (ii) tobacco reduces corrosion in the galvanic aluminum-silver couple immersed in 3.5% NaCl solution and (iii) tobacco dust and aqueous extracts are highly effective corrosion inhibitive pigments in coatings.

Examples are given below to more fully illustrate the invention, and should not be construed as limiting the invention.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

Zero Resistance Ammetry (ZRA)

Zero resistance ammetry (ZRA) studies on the 2024 aluminum and silver galvanic couple and the 2024 aluminum and nickel couple in 3.5% NaCl solution with and without tobacco additions clearly demonstrated that tobacco extracts exerted a marked corrosion inhibitory effect. Among other things, the effectiveness of corrosion inhibition was found to be 95% for a 0.1% by weight addition of tobacco extract and 96.6% for 1.0% by weight tobacco extract compared to the corrosion rate for the Al—Ag couple in 3.5% NaCl solution alone. Visible confirmation of the effectiveness of corrosion inhibition was shown by immersion studies on the aluminum-silver galvanic couple in 3.5% NaCl solution.

Test specimens were prepared using a commercially available primer coating, Deft 44GN098 Chrome-free water reducible epoxy primer and were subjected to electrochemical corrosion (EIS) tests and to accelerated corrosion tests of coated panels (ASTM B117 neutral salt fog testing). Initial electrochemical impedance spectroscopy (EIS) studies were performed on 2024 aluminum panels coated with Deft primer containing 5 wt. % tobacco dust. The EIS data collection began shortly after immersion and was repeated after 1, 3, 7, 14, 21, 28, and 35 days of exposure at which point the test was ended. Visual inspections were performed on data collection days. As shown in Table 1, the EIS data demonstrate that the tobacco addition provide corrosion protection compared to uncoated 2024 Al.

TABLE 1
Impedance values at 1 Hz (means ± std. devns.)
for bare 2024 Al, Deft-coated 2024 Al and 2024
Al coated with Deft + 5% tobacco dust

| Specimen | 0 days | 1 days | 3 days | 7 days | 21 days |
|---|---|---|---|---|---|
| Bare 2024 | 84.35 | | | | |
| Al | | | | | |
| Deft | 40915 ± | 10885.5 ± | 2773.5 ± | 1986 ± | 1239.35 ± |
| | 5550.8 | 10570.5 | 494.3 | 18.4 | 371.4 |
| Deft + 5% | 130615 ± | 3496 ± | 2450 ± | 1527.5 ± | 780.6 ± |
| dust | 78043.4 | 445.5 | 608.1 | 327.4 | 227.8 |

As seen in Table 1, no statistically significant difference (p>0.05) was noted between the impedance values for 2024 aluminum alloy coated with Deft and 2024 aluminum coated with Deft containing tobacco dust. The EIS data for these panels indicated that the coatings suffered predictable water uptake. One DEFT coating without tobacco performed well with the least uptake during the exposure period and no defects. The other tobacco-free DEFT coating and both DEFT+dust coatings contained defects which led to more rapid moisture ingress to the coating/substrate interface. The performances of these specimens will be explored further through tape-pull testing followed by more direct mechanical coating removal to examine the substrate surface.

Initial paint studies were performed by incorporating tobacco dust and aqueous tobacco extract into a chrome-free epoxy primer paint (Deft coating 44GN098). Liquid extract-containing specimens were prepared by admixture of aqueous tobacco extract into the mixed Deft coating and applied to 2024 Al panels at film thicknesses of 5 and 10 mil (0.125 and 0.250 mm). Tobacco dust containing specimens were prepared by dispersion grinding of tobacco dust into the base component of Deft 44GN098 primer paint.

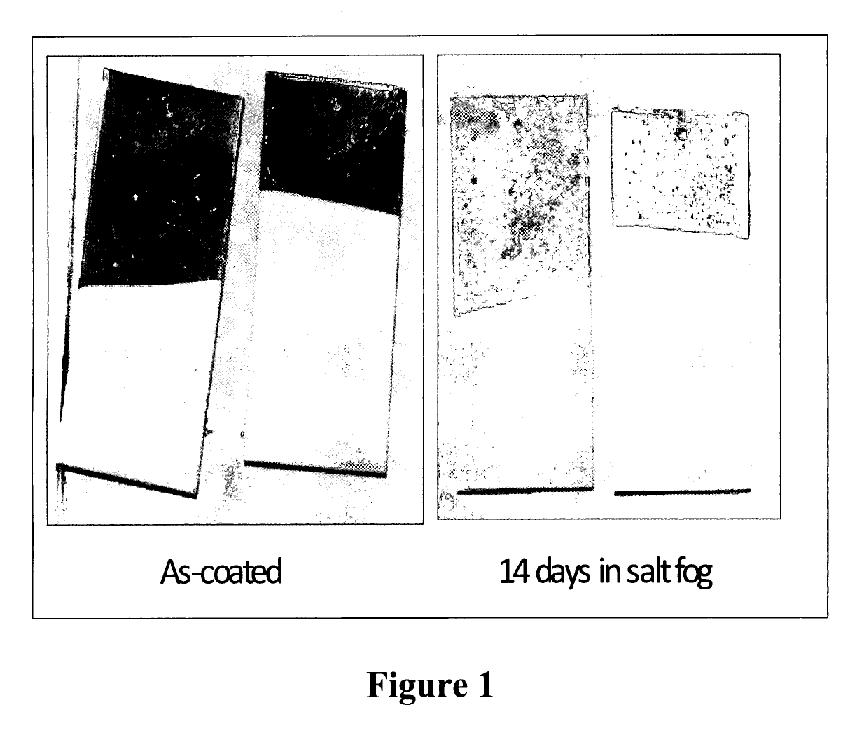

Bare 2024 aluminum showed evidence of marked attack on the aluminum after 14 days' exposure in a salt fog chamber (ASTM B117 neutral salt fog environmental exposure cabinet). The appearance of 2024 Al specimens coated with tobacco-containing Deft Primer after exposure for 14 days in the salt fog chamber is shown in FIG. 1.

There was no evidence of coating breakdown for an exposure period of 300 hours despite the fact that the preparation of the tobacco dust-containing coating was suboptimal compared to standard paint manufacturing technology and that the ASTM B117 testing regimen is noted for its severity. While there were indications of coating disruption by the dust particles and some flaking of the coating, there was no evidence of subsurface and/or filiform corrosion following the initial 300 hours B117 exposure.

Immersion Corrosion Studies

Immersion corrosion tests on 2024 aluminum panels immersed in plain 3.5% NaCl solution and 3.5% NaCl containing 1.56% KY burley extract showed a notable difference between the two sets of specimens, particularly the accretion of salt deposits on the aluminum in plain 3.5% NaCl while no deposits formed on the panels in salt solution containing tobacco extract.

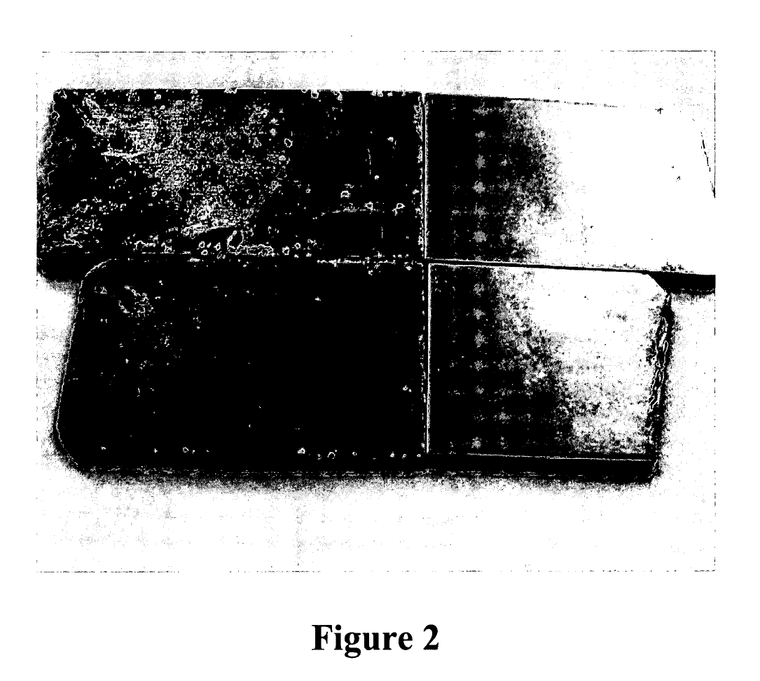

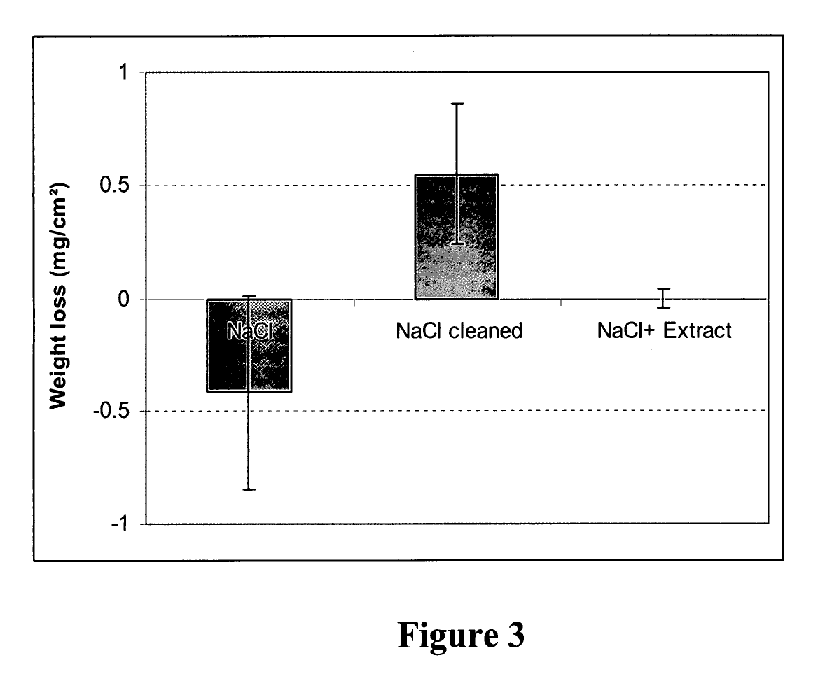

The salt accretion on panels immersed in plain 3.5% salt solution resulted in a net weight gain starting at 42 days. However, after the salt deposits were removed by ultrasonic cleaning, there was a large weight loss for these panels. In contrast, panels exposed to 3.5% NaCl containing tobacco extract showed no net change in weight after 55 days. These data are shown in FIG. 3. In FIG. 2, 2024 Aluminum alloy specimens immersed in 3.5% NaCl solution. Specimens on the left were immersed for 55 days in 3.5% NaCl solution and show clear evidence of corrosion, surface pitting and accretion of salt deposits. Specimens on the right were immersed for 55 days in 3.5% NaCl solution containing 1.47% Kentucky burley extract and show no evidence of corrosion, pitting or salt accretion, clearly indicating the benefit of the presence of tobacco extract in salt water solution with regard to aluminum corrosion.

It was noted that places on the aluminum panels that carried salt deposits showed evidence of pitting after removal of the salt deposit. The finding that the dissolved tobacco solids appeared to prevent accretion of salt was unexpected. The absence of salt deposition is advantageous with regard to pitting attack and may be an unexpected benefit to the use of tobacco and its extracts as a corrosion inhibitor in marine environments.

Electrochemical Studies

EIS studies were performed on treated aluminum panels. Panels were prepared using the maximum recommended dilution of 135% for the Deft coating when mixing the paint with tobacco extract and the control coating with distilled water. The resulting paint had the consistency of a wash and two coats were required to achieve a coherent surface coverage but there were a high number of holidays due to bubbles. This finding indicated that high thinning of the Deft coating is not to be recommended.

Specimens then were prepared using a 15% volume dilution of the Deft paint with one set diluted with liquid KY burley tobacco extract containing 3.56% solids and the other with distilled water. The test panels were coated by dipping to ensure a thicker, more uniform coating. Of the three panels of each set, one each was immersed intact into 3.5 wt % NaCl solution. Two each were scribed with a single line down the center of the immersion area on one side. Above each scribe a single-point holiday was also introduced in the coating. The storage solutions are changed on a weekly basis.

The plots indicated all specimens held up well so far for coatings prepared with paint diluted with water and paint diluted with tobacco extract. A drop in impedance in the midrange frequencies was noted for the scribed panels, but there were no visual signs of corrosion activity at Day 8. Generally the impedance was consistently slightly lower for the extract solution diluted specimens at frequencies higher than those associated with the coating itself. At lower frequencies the plots came together and had a slope of approximately −1, indicating that the coating capacitance was about the same for both series of specimens and that the coatings changed little up to Day 8. Similar findings were found up to Day 36 which marked the end of this test period.

Little change was noted in the outward appearance of the specimens and there was little, if any visual, difference between extract-diluted coated coupons and distilled water-diluted coated coupons.

A mechanism that might explain the electrochemical data was the formation of a protective corrosion product layer at the base of the pores, in which case thicker or more dense films may be forming for the extract-based coating specimen. Alternatively, the actual corrosion reaction was different for the extract-based coating compared to the control coating, and that this different reaction is slower to consume the substrate exposed to the pore solution although it is possible that the pore solution itself had been altered by leaching extract from the coating, leading to a less aggressive pore environment. The data to date indicate that the tobacco extract had not reduced the functionality of the coating, and may indeed have reduced corrosion rates in the pores.

Immersion Corrosion Studies

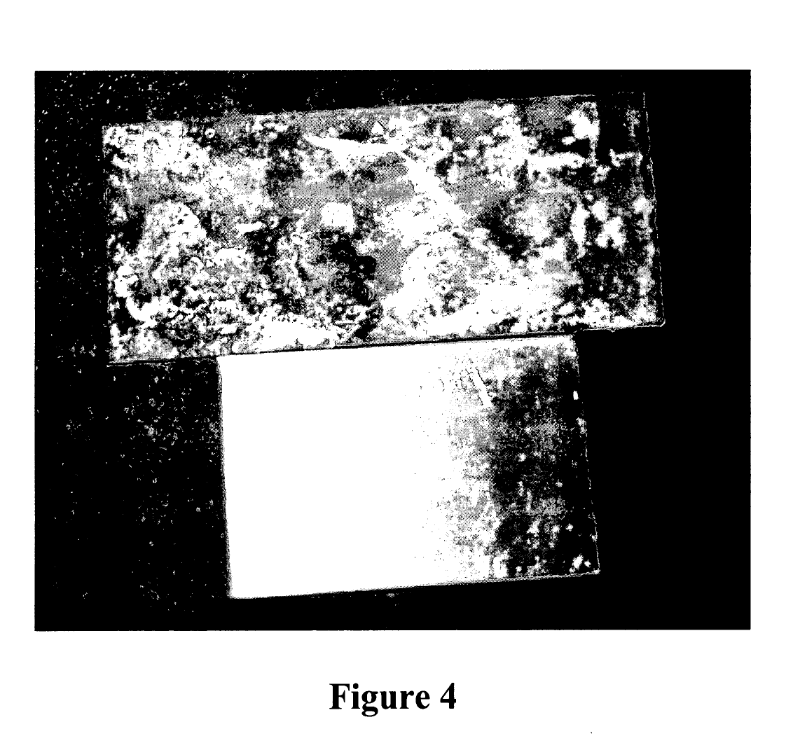

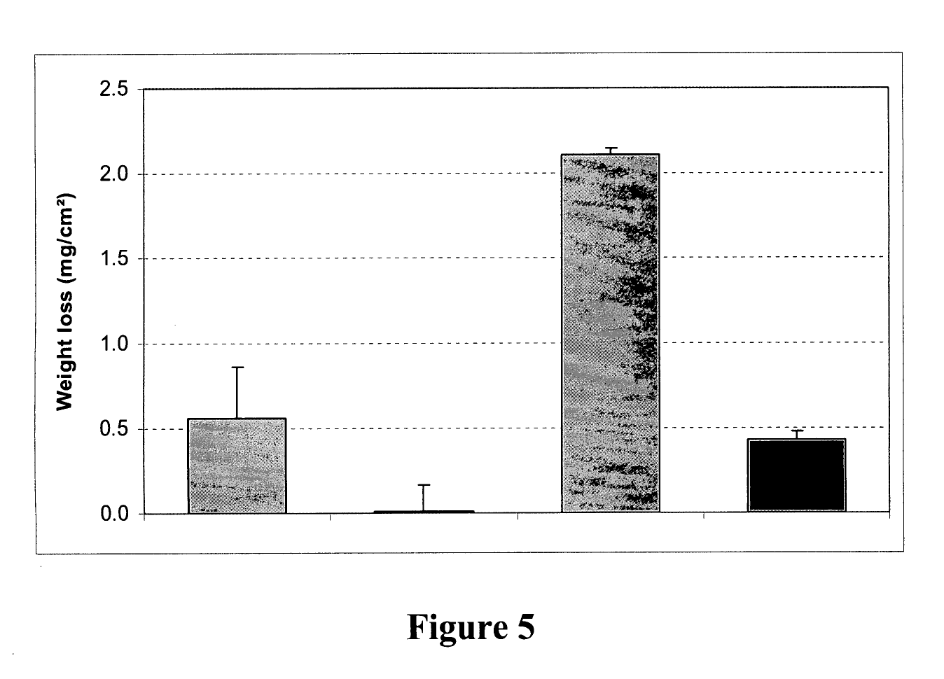

Immersion tests on 2024 aluminum panels immersed in plain 3.5% NaCl solution and 3.5% NaCl containing 1.56% KY burley extract were performed for a period of 55 days. The appearance of the specimens is shown in FIG. 4. A notable difference between the two sets of specimens was the extent of corrosion on the aluminum in plain 3.5% NaCl while minimal attack occurred for the panels in salt solution containing tobacco extract, FIG. 5.

The data indicate that prolonged exposure resulted in marked increases in corrosive attack on the aluminum with longer immersion but it was found that the presence of 1.56% tobacco extract in the 3.5% NaCl reduced the corrosivity of the salt solution by 80%.

Salt Fog Testing

The corrosion testing methods used in this program incorporate ASTM test standards: D610-01 Evaluating Degree of Rusting on Painted Steel Surfaces', D5894-96 Cyclic Salt Fog/UV Exposure of Painted Metal¹, D714-02 Evaluating Degree of Blistering of Paints, and D1654-92 Evaluation of painted or Coated Specimens Subjected to Corrosive Environments². These standards are used to evaluate the degree of corrosion, blistering, and peeling of coatings on surfaces following exposure to cyclic salt fog corrosive environments.

Test specimens were coated with a two-part non-chrome containing epoxy primer provided by Deft Chemicals, MIL-PRF-85582. In addition to specimens coated with primer alone, tobacco extract prepared using green leaves, cured tobacco, and tobacco dust, was added to the epoxy primer for testing. Tobacco dust concentrations varied from 1-10% by weight while liquid extract concentrations varied from 1-50% by volume for specimens containing liquid tobacco extract.

Testing Protocol: All specimens were prepared by coating 2024 aluminum coupons with mixtures of either liquid extract and primer, or tobacco dust and primer. Specimens also varied between 0 and 10 weight percent for both liquid extract specimens and tobacco dust specimens.

The testing protocol for the salt fog chamber runs a cycle of 1-hour fog at ambient temperature and 1-hour dry-off at 35° C. The fog electrolyte is a solution containing 0.05% NaCl and 0.35% (NH₄)₂SO₄. Specimens were placed within the chamber on glass and all specimens were washed with de-ionized water after treatment to remove any salt residue.

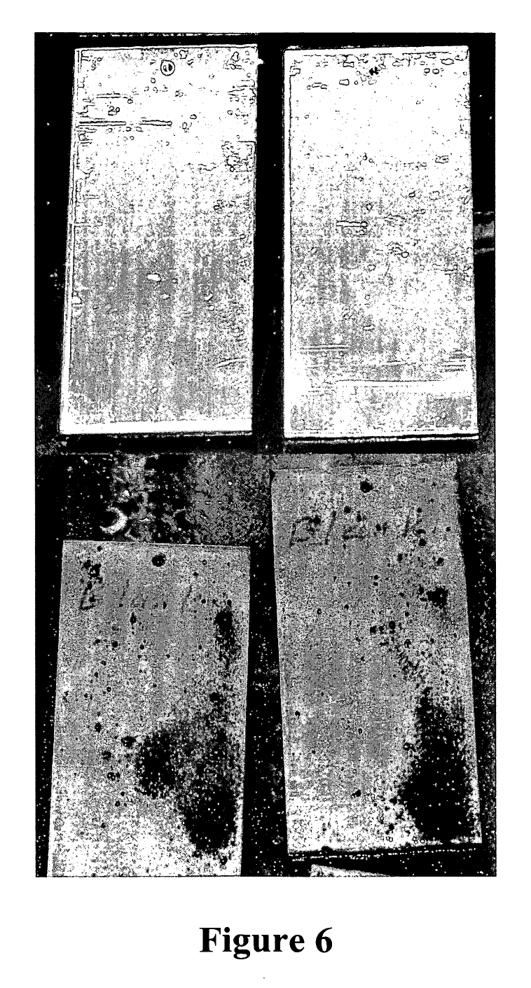

Initial specimens were tested in the salt-fog chamber for a period of approximately 150 hours to determine if corrosion of the 2024 T3 aluminum would begin as illustrated in FIG. 6. Once corrosion of specimens occurred, two batches of specimens were prepared for further testing. The majority of specimens discussed in the following section experienced salt-fog cycles for a period of approximately 500 hours.

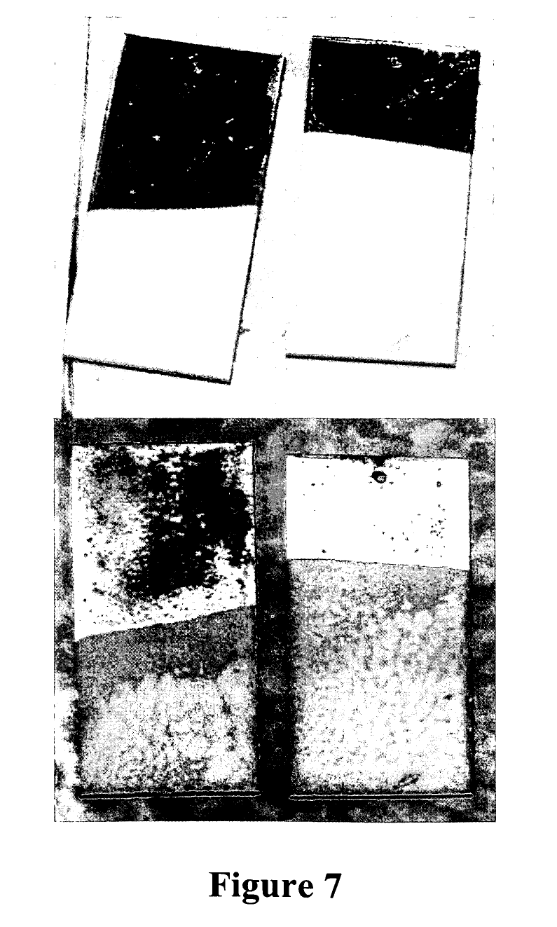

Test Results: The uncoated aluminum specimens placed in the salt fog chamber for 500 hours showed pinpoint corrosion along the edges of the specimens and general corrosion of levels between 3-G (16%) and 4-G (10%) occurred on both specimens as described by ASTM standard D610. FIG. 7 shows 2024 T3 aluminum dip coated specimens with pure polyamide primer pre- and post-exposure in the salt-fog chamber for 500 hours. Corrosion of the bare metal is apparent and while the specimens did not undergo general corrosion, there was pinpoint corrosion of levels between 5P (3%) and 4P (10%). However, the primer coating itself underwent little change although some ‘waving’ and discoloration of the specimens occurred. The discoloration of some portions of the sample is most likely a result of retained salt residue following rinsing.

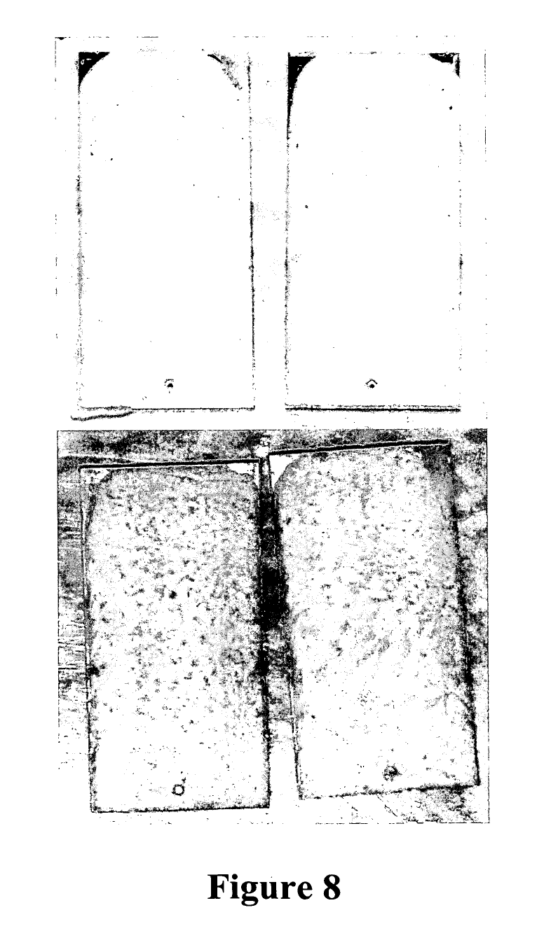

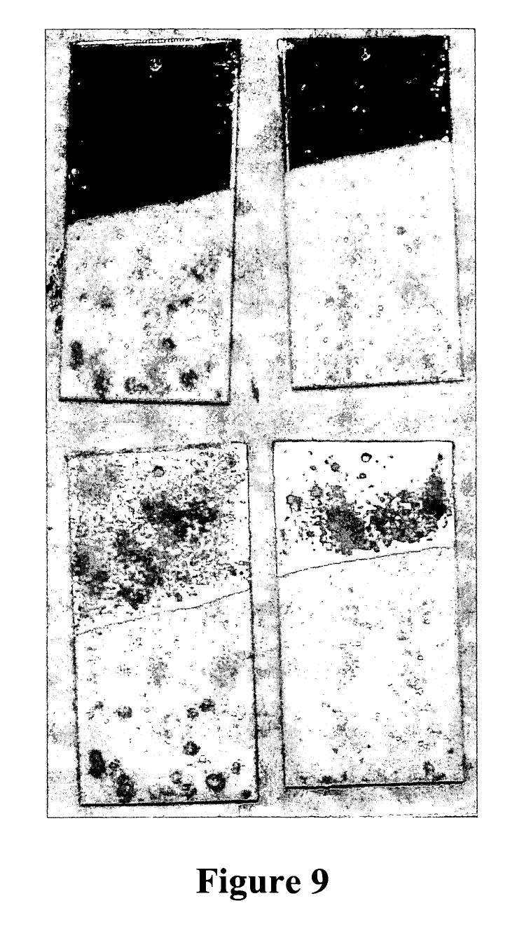

FIGS. 8 and 9 show specimens with 1 wt % and 5 wt % tobacco dust added to the primer mixture before and after salt fog treatment. Although most of the surface is covered with the primer mixture, some pitting is noticeable on the corners of the pure metal specimens. Again, as seen in FIG. 6, discoloration of the primer occurred.

It was noted that at tobacco dust loading above approximately 3% by weight, coating of the mixture became difficult and bubble imperfections in the coating were noted on the specimens (as illustrated in FIG. 9). The loading did not adversely affect adhesion of the mixture to the substrate metal. Following salt-fog exposure, no discoloration of the primer coating was observed, unlike the specimens in FIGS. 8 and 9. However, during corrosion testing some bubbles became more pronounced and others opened to the salt environment. General corrosion occurred at a level between 3G (16%) and 4G (10%).

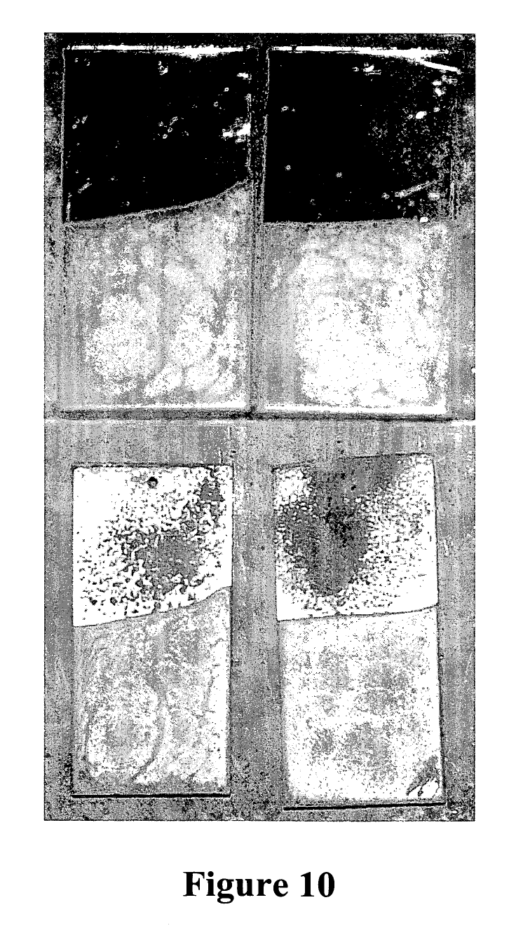

FIG. 10 shows two specimens with 1 wt % liquid tobacco extract added to the primer. The specimens showed the “wave effect” before and after corrosion testing. Pitting and general corrosion of the bare areas of both specimens occurred at levels between 2G (33%) and 1G (50%).

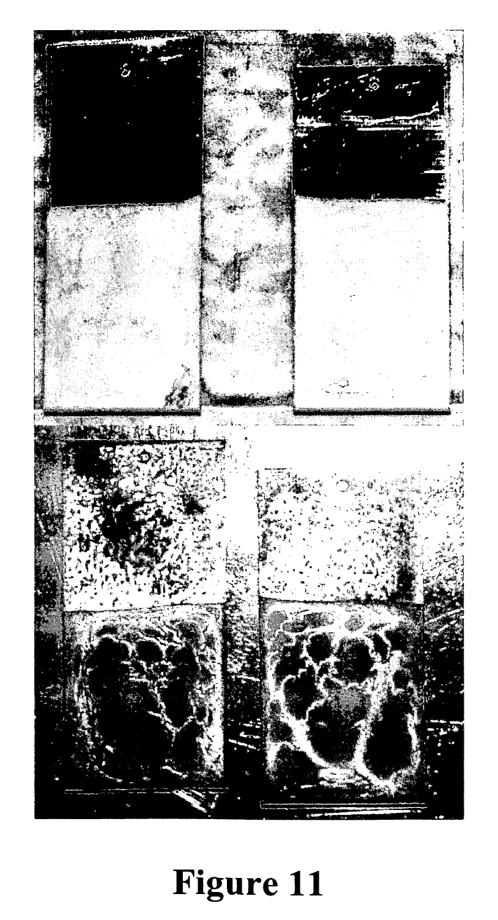

FIG. 11 shows a “wave effect” of the primer coating before salt fog treatment and the overall effect of the salt fog cycles slightly changed the pattern of the waves in the coating. However, the primer mixture maintained excellent adhesion to the surface of the aluminum. Pitting occurred at a level between 2G and 3G. No corrosion took place under the surface of the primer coating.

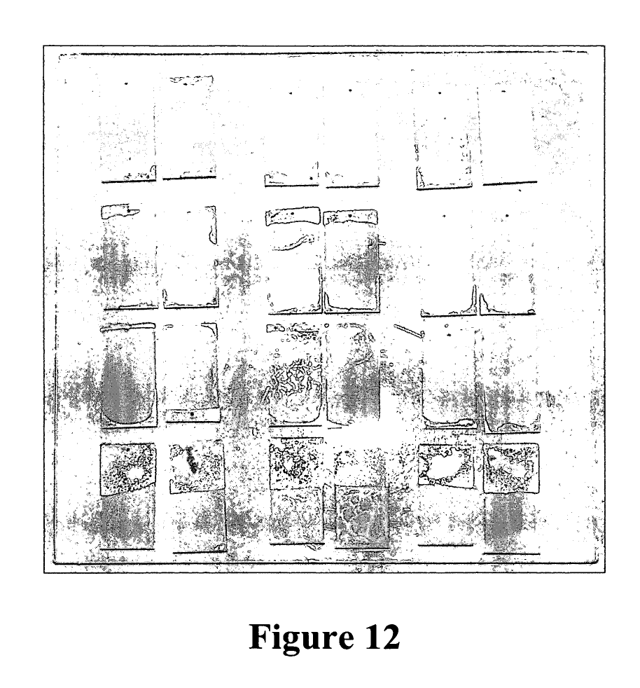

FIG. 12 shows columns of 2024 aluminum coated with primer containing 1 wt %, 5 wt % and 10 wt % additions of liquid tobacco extract and then exposed in the salt fog chamber for 500 hours. The film thickness on the specimens increased from top-to-bottom of the columns (1, 5 and 10 mil, where 1 mil=0.001 inch) while the last row of specimens was dip-coated. Some discoloration and spotting was visible on the coated samples but no corrosion occurred on the coated portions of the specimens.

Based on the foregoing, the data evidences that tobacco additions to the primer reduce the corrosion of the aluminum substrate without detriment to the overall coating quality.

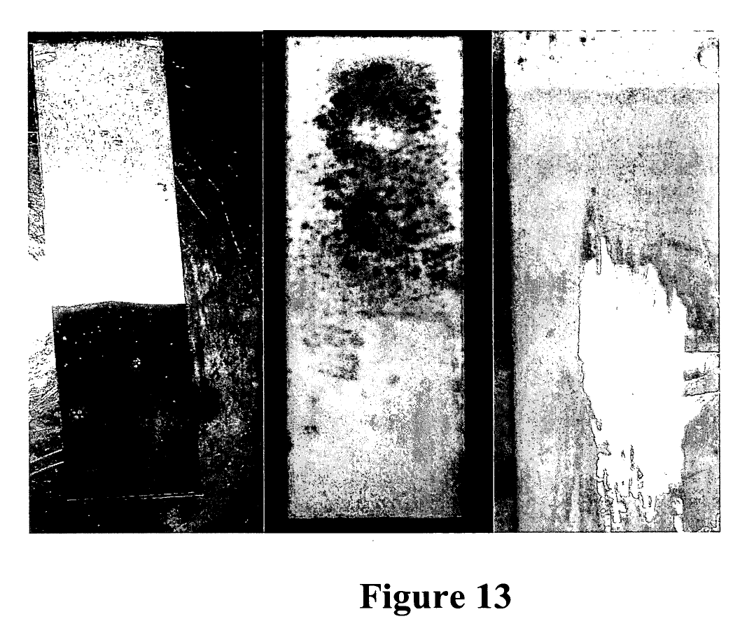

FIG. 13 shows the surface of a 2024 Al sample coated with the epoxy primer before and after the coating was removed to show the absence of pitting. The images on the left and in the middle show the effect of loading primer with a high amount (approximately 50% by weight) of liquid extract while the image on the right shows that although there was flaking of the coating due to the high tobacco content, there was no corrosion of the aluminum substrate. These findings suggest that liquid extract loading amounts should remain below 20% by volume to help maintain the properties of the epoxy primer.

As shown in Table 2, weight change determinations showed considerable variability in specimen weights. Thus, determining the degree of corrosion was not possible by traditional weight change measurements. Accordingly, the degree of corrosion was determined in accordance with ASTM standard D610.

TABLE 2
Pre- and post-salt fog exposure weights (g) of aluminum specimens
for samples with primer containing liquid tobacco extract

| Pure Primer Specimens | | 1 wt % liquid extract | | 5 wt % liquid extract | | 10 wt % liquid extract | |
|---|---|---|---|---|---|---|---|
| Before | After | Before | After | Before | After | Before | After |
| 5.3471 | 5.5384 | 5.3323 | 5.2767 | 5.2854 | 5.2874 | 5.3286 | 5.3160 |
| 5.5291 | 5.3649 | 5.5072 | 5.5222 | 5.3746 | 5.3573 | 5.4363 | 5.2650 |
| 5.3112 | 5.5772 | 5.5909 | 5.5853 | 5.5792 | 5.5880 | 5.2655 | 5.3983 |
| 5.4561 | 5.2890 | 5.4130 | 5.4354 | 5.7912 | 5.5890 | 5.9441 | 6.1009 |

It was noted that the pure epoxy primer layer adhered extremely well to the aluminum surface. There was no visible flaking or peeling of the primer layer after salt fog testing. The addition of non-optimized tobacco dust to the primer affected coating adhesion to the specimens and at tobacco additions greater than 5 wt %, the primer-tobacco mixture adhered poorly to the surface of the aluminum very easily. At tobacco dust loadings greater than 5%, it was not possible to obtain a 1, 5, or 10-mil thick coating. At higher loadings of tobacco dust, it becomes extremely difficult to prepare samples with a uniform coating. This data suggests that making high additions of tobacco dust to primers is a less favorable method of utilizing tobacco for corrosion inhibition.

The addition of liquid extract with the epoxy primer had no significant effect on the adhesion of the epoxy-tobacco mixture but at high loading, at approximately 1:1 ratio of tobacco extract to primer, flaking was observed. Based on this, liquid extract additions might usefully be limited to approximately 10% by weight in order to maintain good adhesion of the primer-tobacco mixture.

Electrochemical (EIS) Studies

EIS studies performed with a Gamry 600 AC/DC potentiostat and associated software were continued on 2024 aluminum specimens carrying the unmodified primer and primer containing tobacco extract for a total of 90 days. All test specimens plus controls were prepared together by dip-coating to produce a relatively thick and uniform coating. The coatings were based on a DEFT two-part epoxy; the control was diluted with distilled water (15% by volume) and the experimental inhibitor coating was diluted with prepared tobacco extract (15% by volume). The tobacco extract solution contained 3.56% extracted tobacco solids.

Full Immersion Specimens

Five panels were prepared with DEFT diluted 15% with tobacco burley extract, and five controls using DEFT diluted 15% with distilled water. Application was performed by dipping the coupons for a thick, uniform coating. Two panels of the test coating and two of the controls were held in reserve; one each for use in a flat cell and one each as unexposed comparison panels.

Of the remaining three panels of each set, one each was immersed intact into 3.5 wt % NaCl solution. Two each were scribed with a clean razor blade in a single line down the center of the immersion area on one side. Above each scribe a single-point holiday was also poked through the coating. The distilled water coupons are stored immersed in a separate container from the extract coupons to avoid potential issues with leaching of extract-related compounds. The storage solutions were changed once per week. The total exposure was approximately 3 months in duration. Visual inspections were made on data collection days, but there was little visible change in these thick defect-free coatings over the test period. The electrochemical data and visual inspections indicated that the specimens held up well, both with and without extract, over the exposure period.

An external noise issue interfered with the data collection on Day 0 and persisted into Day 1. The use of a Faraday cage eliminated most of the noise issues and allowed collection of the EIS data again. Faraday cage shielding was used for the remainder of the full immersion measurements. The loss of the Day 0 EIS data, usually collected within an hour or two of initial immersion, did not present a problem.

Constant phase elements act as capacitors in a circuit if the exponent associated with their impedance equals 1.0. For exponent values between 0.5-1.0 the CPE can represent a combination of capacitive and diffusion-limited behavior. The initial pair (Rₚₒ/C_{c}) represents the pore resistance and coating pseudo-capacitance. The first nested pair (Rᵢₙₜ/Cᵢₙₜ) follows Rₚₒ and represents an intermediate mechanism probably related to diffusion of reactants and products to and from the coating/metal interface or the solution/metal interface inside pores, possibly combined with parallel ionic pathways unrelated to pores. The second nested pair (R_{cor}/C_{cor}) follows Rᵢₙₜ and represents any corrosion mechanism(s) and pseudo-capacitance (e.g. double layer capacitance at the base of pores) associated with the metal surfaces. The exponents n, m, and p are associated with the CPEs C_{cor}, C_{c}, and Cᵢₙₜ respectively.

Based on this model, the values of Rₚₒ and Rᵢₙₜ quickly attain relatively low but slowly rising values which seem to imply reasonably stable or at least only slowly changing pore environments after the first week. The coating pseudo-capacitance C_{c} changed more rapidly, however, as discussed below.

The intermediate resistance values (Rᵢₙₜ) for both specimens tended to track with Rₚₒ, however the intermediate CPE pseudo-capacitance (Cᵢₙₜ) tended to track with C_{cor}, the pseudo-capacitance associated with the metal/solution or metal/coating interface. The explanation for this trend in the model is not fully understood, but is presumed to describe through-coating diffusion to some extent.

The coating pseudo-capacitance C_{c} started low as might be expected for a coating, but stepped up to a higher value at the 29-day measurement for both coatings suggesting an increased rate of moisture absorption over the week since the previous measurement. During that same period the exponent value for C_{c} (m) dropped suddenly for both specimens indicating an increased deviation from strictly capacitive behavior.

The other most notable change in the exposure period was the in the corrosion resistance R_{cor}. This equivalent circuit element is thought to be the one most closely related to the reaction rate at the surface of the aluminum substrates; higher resistance should indicate slower reaction rate. The interesting occurrence here is that the fitted R_{cor} value so far has been rising for both specimens, and more rapidly for the extract specimen. If one accepts the model, this suggests that reactions occurring at the metal surface, perhaps within pores in the coating, are slowing down. One mechanism that explains the behavior is the formation of a protective corrosion product layer at the base of the pores, in which case thicker or more dense films may be forming for the extract-based coating specimen. Another interpretation is that the actual corrosion reaction is different for the extract-based coating compared to the control coating, and that this different reaction is slower to consume the substrate exposed to the pore solution. Yet another interpretation is that the pore solution itself has been altered by leaching extract from the coating, leading to a less aggressive pore environment.

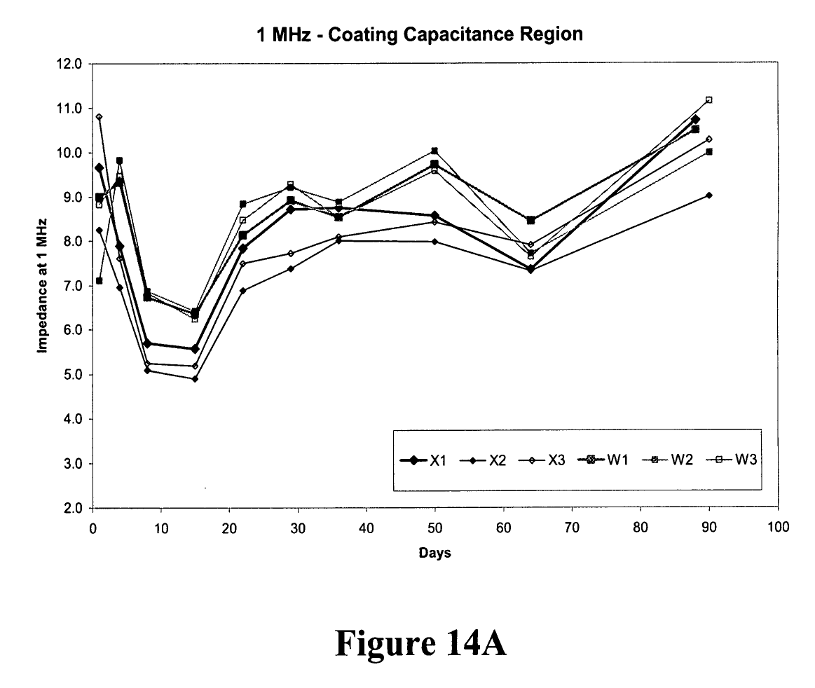

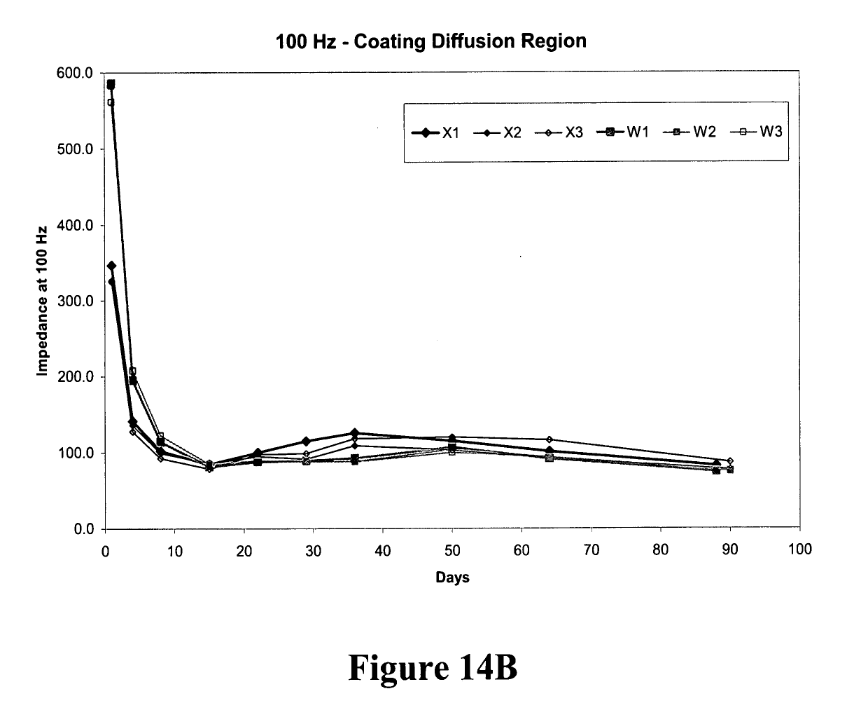

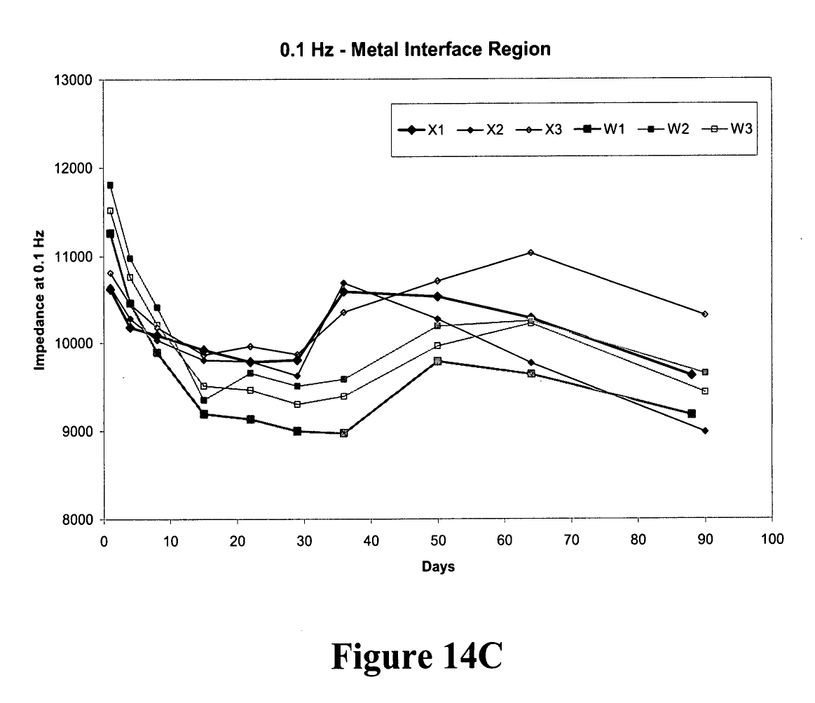

It is important to note, however, that the R_{cor} parameter was the most difficult to model accurately as there has been little indication of an impedance plateau at the lowest frequencies. As a result it is largely interpolated from the sloped region which introduces a greater opportunity for modeling error. One method to reduce potential error in R_{cor} would be to collect data to lower frequencies, however this greatly extends the period of time a single measurement can take. While strict interpretation of the equivalent circuit model and its parameters can be challenging, the modeling results do help to illuminate which frequency ranges are most greatly affected by specific modeling components. The result is that the impedance at particular frequencies may be plotted versus exposure time to give an indication of some trends. In the plots shown in FIG. 14, the impedance values at three different frequencies are shown. The highest frequency data is closely associated with the coating capacitance. The behavior of the data in the most rapidly changing regions, roughly between 1 Hz and 100 KHz, appears to be associated with ionic diffusion between the metal substrate and the solution. Such diffusion must take place through the coating and through any solution layers that may form next to the metal surface through coating delamination. At the lower frequencies the data with slope≈−1 appear to be describing the capacitance associated with any moisture at the metal interface.

FIG. 14A shows data points over time for each specimen at 1 MHz in the region dominated by the coating capacitance. FIG. 14B shows the data at 100 Hz in the region dominated by diffusion mechanisms through the coatings. FIG. 14C shows the data at 0.1 Hz in the region dominated by conditions at the metal interface.

The 1 MHz region of the spectra depicted is dominated by the coating capacitance. The relationship between impedance and capacitance is inverse, therefore higher impedance indicates lower capacitance. The dielectric constant of water at room temperature is typically more than an order of magnitude greater than that of many organic coatings, and capacitance is directly proportional to the dielectric constant of a material. Hence, reduced capacitance over time can be associated with water uptake in immersion, as shown in Days 1-13. It is not immediately clear why there was a capacitance decrease again after 13 days. One possible explanation is swelling; capacitance is inversely proportional to distance which in this case is the coating thickness. A thickness increase would then lead to a reduction in capacitance and an increase in impedance. Generally the extract coatings tended to have lower impedance/higher capacitance than the control coatings. It is not immediately obvious what impact this will have on corrosion performance. The specimens otherwise tracked each other fairly closely.

The 100 Hz region of the spectra in FIG. 14B is dominated by the diffusion of ionic species through the coating and any additional interfacial layers that may exist between the coating and the metal substrate. An example might be moisture accumulation in a delaminated region of the coating. Lower impedance suggests a more rapid diffusion rate. Note that prior to 13 days the impedance of the extract coatings was lower than the controls, but after 13 days the impedance rose above the fairly stable control set. This suggests slower diffusion rates for the extract coatings during that time. By Day 50 and subsequently, the two coatings groups began to draw closer together.

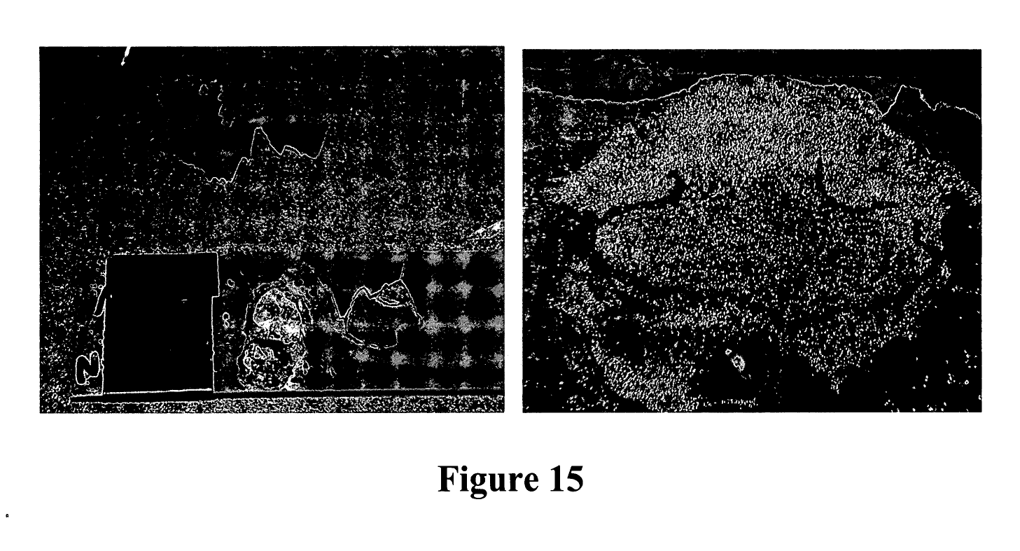

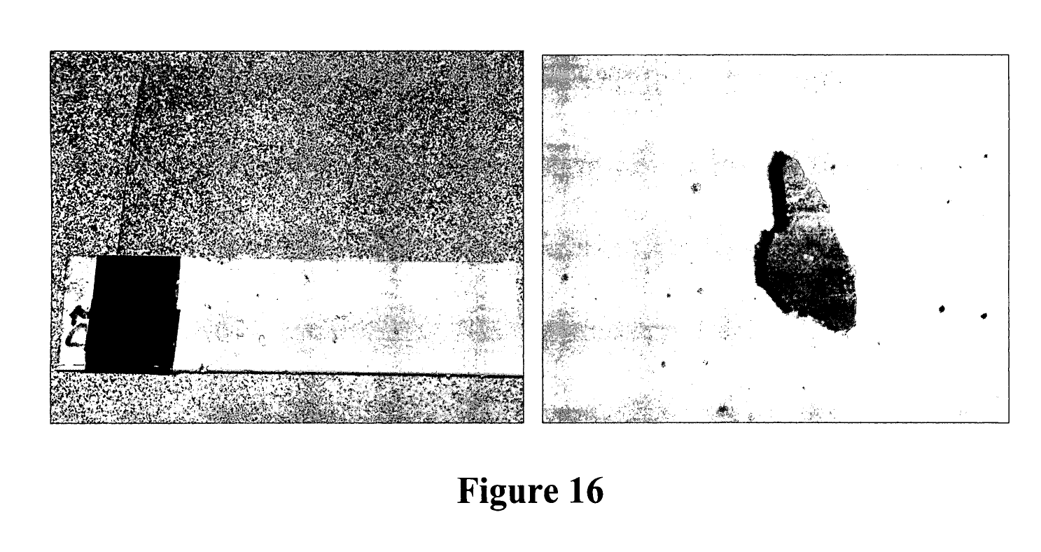

The 0.1 Hz region of the spectra is dominated by the environment at the metal interface. Since the data around this frequency had a slope of nearly −1 in the Bode magnitude impedance spectra, it is reasonable to associate the behavior of these specimens at 0.01 Hz with the double layer capacitance that forms as moisture accumulated at a metal/coating interface. As discussed earlier, it would be necessary in these cases to extend the data collection to lower frequencies to reveal the charge transfer resistance associated with any corrosion reactions taking place at the metal surface. Higher impedance indicates lower capacitance, but in this case the meaning is different than in the 1 MHz case which was related strictly to the coating. From Day 8 to Day 50 the control data on average were lower than the extract data. One interpretation is that there are different reactions taking place at the metal interface between the controls and the extract coatings. This would not be unexpected especially after the tape test results discussed below (see FIGS. 15 and 16). Another interpretation is that there is a difference in contact area. Capacitance is directly proportional to area. If a delamination is assumed, for example, a smaller delaminated area in the case of the extract specimens would result in a lower capacitance and, consequently, a higher impedance. Again recalling the results of the tape test on the earlier specimens with thinner coatings plus defects, it was clear that the delamination was far less extensive in the extract specimen and that much more aggressive corrosion was underway on the control specimen.

After Day 50, the behaviors of the extract coatings started to diverge. The drop in impedance, especially for the scribed specimen X2, appears to indicate that some accelerated corrosion activity may have finally started at the scribe. However, in the final visual and optical microscope inspection of all of the specimens no evidence of attack was found on any specimen, intact or scribed. The tape test failed to remove any coating, and additional attempts to physically peel the coating only led to substrate damage indicating that by the end of 3 months both the extract and control coatings were still physically strong and well-adhered to their substrates.

Flat Cells

Testing of flat cell specimens was initiated in order to provide a less complicated test surface. One intact control and one intact extract specimen was examined. The exposed surface areas were on the order of 30 times smaller than the full immersion panels. The exposed areas were flat, as the cell name suggests, and had no edges or corners to increase the possibility of unintended defects. Due to the cell configuration, the solution could not be changed during the exposure period; however, all openings were kept loosely covered to slow evaporation and limit contamination.

DEFT Coatings with Tobacco Dust

Two specimens were prepared with full strength DEFT and two with full strength DEFT plus tobacco dust (5% by weight in the base component of the two part epoxy). These four specimens were immersed into slightly acidic 3.5 wt % aqueous NaCl solution (pH 6). EIS data collection began shortly after immersion on 7 Sep. 2007 (Day 0) and was repeated after 1, 3, 7, 14, 21, 28, and 35 days of exposure at which point the test was ended. Viual inspections were performed on data collection days.

One DEFT coating performed well with the least uptake during the exposure period and no defects. One DEFT coating and both DEFT+dust coatings contained defects which led to more rapid moisture ingress to the coating/substrate interface. In the case of the DEFT+dust coatings the defects mainly consisted of larger pieces of dust that disrupted the coating. Future attempts to produce test specimens should include a step that filters out larger particles, or pulverizes the dust into more consistent smaller particles. In the case of the control DEFT coating two blisters formed as a result of edge defects. The performances of the three specimens with defects were explored further through tape-pull testing followed by more direct mechanical coating removal to examine the substrate surface.

The tape pull test was performed using a standard pressure-sensitive adhesive tape pressed strongly and completely onto the coating surface after the coating was allowed to dry to the touch. The tape was then pulled back rapidly and the resulting coating loss was recorded photographically. The DEFT coating with blisters, shown in FIG. 15, lost a substantial coating area in this test, and adjacent large areas of coating loosened from the substrate as well. On the exposed substrate surface spotted areas of relatively mild corrosive attack were found between two main blister areas. The main blister locations themselves were characterized by widespread pitting of the aluminum substrate, dissolution and re-deposition of the copper component, and the formation of clear, stacked, crystalline particles. Acid hydrolysis was likely occurring inside the main blister locations, as evidenced by the condition of the substrate as well as the presence of gas bubbles continuously forming on the surface of the coating blisters while immersed.

The tape-pull tests of the DEFT+dust coated panels were very similar to one another and substantially less severe than that of the blistered DEFT panel. An example is shown in FIG. 16. The vast majority of the coating resisted the tape pull; however, the coating was slightly lifted around the small locations where breaks occurred.

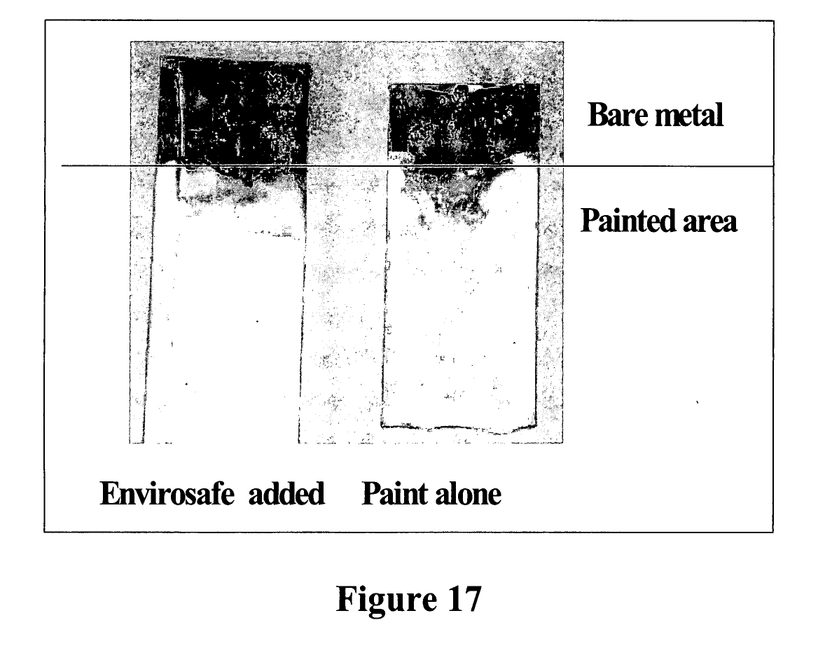

After the pull test, the edges of the coating were observed to be lifting from the substrate around the few small areas where breaks occurred. These areas were exposed further through more aggressive coating removal; the lifted sections were separated from the substrate using tweezers as a wedge. Substantial coating areas could be removed in this manner, as shown in FIG. 17. The underlying substrate was dull and exhibited spotted areas of relatively mild corrosive attack similar to that found between two main blister areas. However none of the more serious corrosion events associated with the blisters (pitting, dense copper dissolution/redeposition) were found here.

These results indicate that even when defects are present in the coating allowing the rapid ingress of moisture to the coating/substrate interface, the presence of solid tobacco particles in the coating plays a role in slowing the corrosion rate generally and possibly blocking particular reactions all together.

### CONCLUSIONS

The findings of this study indicate that tobacco additions to primer coatings, both as dust and as liquid tobacco extracts, provide corrosion protection to the 2024 substrate. Further, there are indications that the presence of tobacco may change the nature of the corrosion reactions. Pilot potentiostatic polarization studies indicate that both the cathodic and the anodic reactions are polarized by the presence of tobacco in solution. These reaction polarization effects result in a shift of the corrosion potential to more noble values and reduced cathodic and anodic current densities compared to bare aluminum in 3.5% NaCl.

EIS and some preliminary polarization studies (not reported here) were performed on the recommended MIL-specification primer, Deft 44GN098 Chrome-free water reducible epoxy primer. Although the primer supplied by the manufacturer was ostensibly manufactured without corrosion inhibitors present in the formulation, the tested formulation in fact appeared to contain inhibitors. This conclusion was reached after all data were analyzed. As a result, while the data presented here indicate the high effectiveness of tobacco as a corrosion inhibitor, test data might be even more impressive if an inhibitor-free primer had been supplied for the test program for comparison purposes.

Additions of both tobacco dust and aqueous tobacco extract were made to the primer. It was noted that dust additions above 5 wt. % increased the mixed coating viscosity so that surface coating was difficult at high loadings. Further, because the tobacco dust particle size range was not optimized, many coatings showed evidence of holiday formation. Nevertheless, despite these disadvantages, the dust-containing coated specifications exhibited excellent performance and, despite the presence of defects within the coating, there was no evidence of substrate attack in salt fog testing or in EIS studies. Further, it was noted that for both tobacco dust and liquid extract additions to the test primer, there appeared to be no detrimental effects on coating adhesion to the substrate.

Salt fog chamber data indicate that additions of tobacco dust and liquid tobacco extracts provided excellent corrosion protection to the 2024 substrate and, further, had no deleterious effects on the stability of the coating. It was concluded that tobacco dust additions should be limited to approximately 5 wt. % and liquid extract additions to 10 wt. % to ensure optimum coating performance when Deft 44GN098 Chrome-free water reducible epoxy primer (as supplied) is used as the primer. Different addition levels are clearly possible in coatings formulated without inhibitive pigments.

The study results show that in coatings that perform well, tobacco additions to the coating provided excellent corrosion inhibition over a 3 month test period. Clearly, longer test periods should be undertaken to completely demonstrate the usefulness of the tobacco additives as corrosion inhibitors. In cases where the coatings contained defects, and so can be expected to fail in a relatively short test period, the tobacco additive (particulate dust in this study) appeared to slow the corrosion damage to the substrate. The findings suggest that even when defects are present in the coating and allow the rapid ingress of moisture to the coating/substrate interface, the presence of solid tobacco particles in the coating plays a role in slowing the corrosion rate overall and possibly also blocks particular reactions all together. The mechanism of this effect was not definitively determined, but may have been related to reduced reaction rates or a change in the reactions themselves.

The findings of this study indicate that tobacco additions to primer coatings, both as dust and as liquid tobacco extracts, provide corrosion protection to the 2024 substrate. Further, there are indications that the presence of tobacco may change the nature of the corrosion reactions. Pilot potentiostatic polarization studies indicate that both the cathodic and the anodic reactions are polarized by the presence of tobacco in solution. These reaction polarization effects result in a shift of the corrosion potential to more noble values and reduced cathodic and anodic current densities compared to bare aluminum in 3.5% NaCl.

Overall, this study has demonstrated the effectiveness of tobacco in inhibiting the corrosion of 2024 aluminum alone and when coupled to silver, the latter situation being found with conductive coatings. It would be advantageous to undertake limited additional R&D studies to optimize tobacco dust and liquid extract additions to epoxy primers. Further, longer term EIS and salt fog testing would be useful to evaluate long term effectiveness of tobacco use as an inhibitive pigment in primer coatings.

Although this study was primarily performed upon aluminum and alloys thereof, the tobacco-based inhibitor products of the invention are also applicable to other metals and their respective alloys, including, for example, iron and ferrous alloys, copper and copper alloys (e.g., brass, bronze), nickel and nickel alloys, and zinc and zinc alloys.

Paints Applied to Steel

Protective paints are applied to a very wide variety of metals and alloys, including iron and steel, aluminum and its alloys, copper and its alloys such as brass and bronze as well as a very wide variety of other metals.

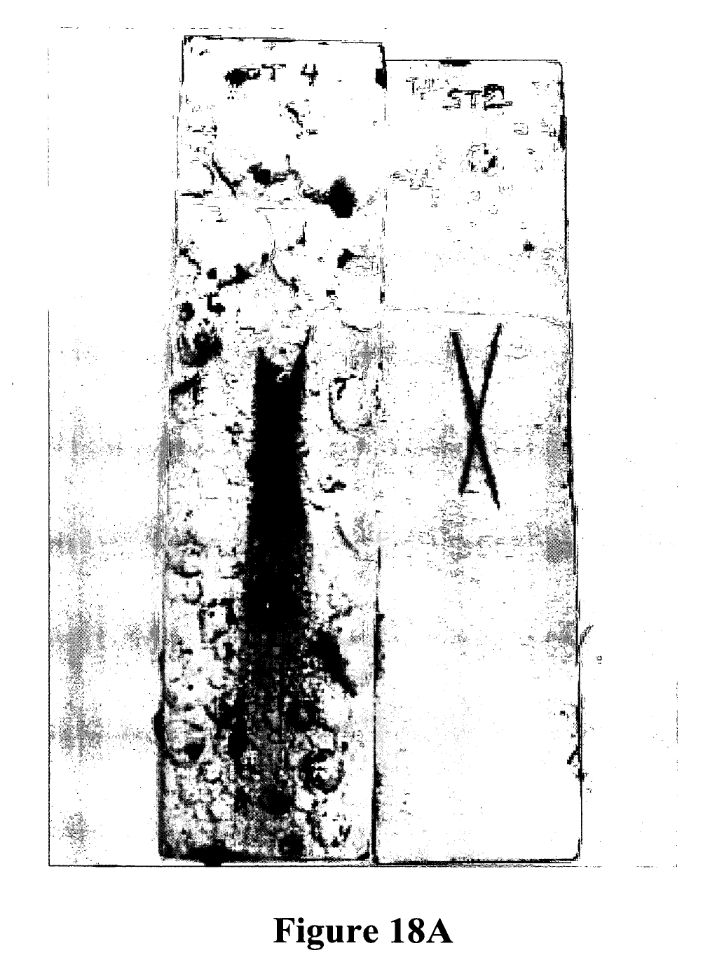

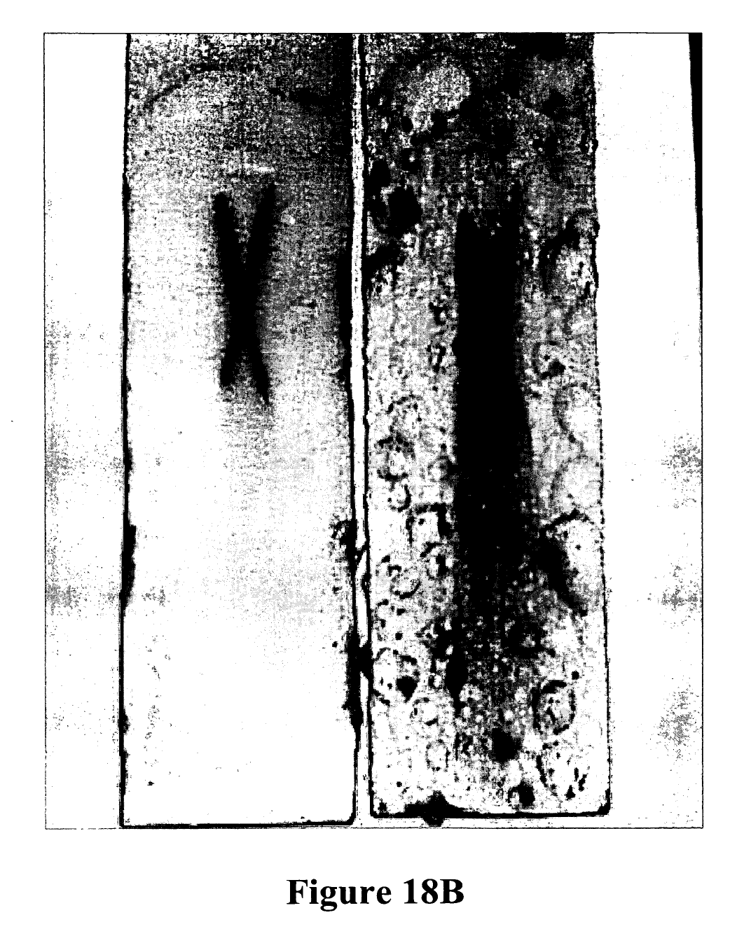

FIGS. 17 and 18 show the benefits of tobacco extract additions to a commercial decorative paint applied to mild steel panels when the steel panels are subjected to a 3% salt spray treatment, as seen in FIG. 18.

The corrosion inhibitive efficacy of the tobacco-based inhibitor products of the invention is seen in FIG. 17 (left). The addition of the tobacco-based inhibitor products of the invention markedly reduced attack on the substrate steel during intermittent salt spray exposure over 24 hours.

The bare metal at the top of the metals of both panels shows clear evidence of corrosion and pitting. The painted steel without tobacco (right hand side) shows corrosion of the steel beneath the paint over the entire face of the panel. In contrast, the steel coated with paint containing tobacco extract shows no attack (i.e., no presence of rust) over the face of the panel (left hand side).

Additions of 0.3% the tobacco-based inhibitor products of the invention to latex paint (FIG. 18, left) and oil paint (FIG. 18, right) show the inhibitive effect of even low additions of these tobacco-based materials to paints. When tobacco is added to the paint, the corrosion only occurs at the X-incisions present in the coating to demonstrate the possibility of corrosion when imperfect coatings exist on the metal surface.

FIGS. 17 and 18 presented here indicate that even under less than optimal incorporation conditions, the addition of the tobacco-based inhibitor products of the invention in liquid or solid form to both water-based (latex) and oil-based paints has a dramatic effect on corrosion protection. Given the low cost, environmental acceptability, high effectiveness and simplicity of application, this new technology has great potential as a corrosion inhibiting pigment within a wide variety of protective paints.

Comparison to Chromates

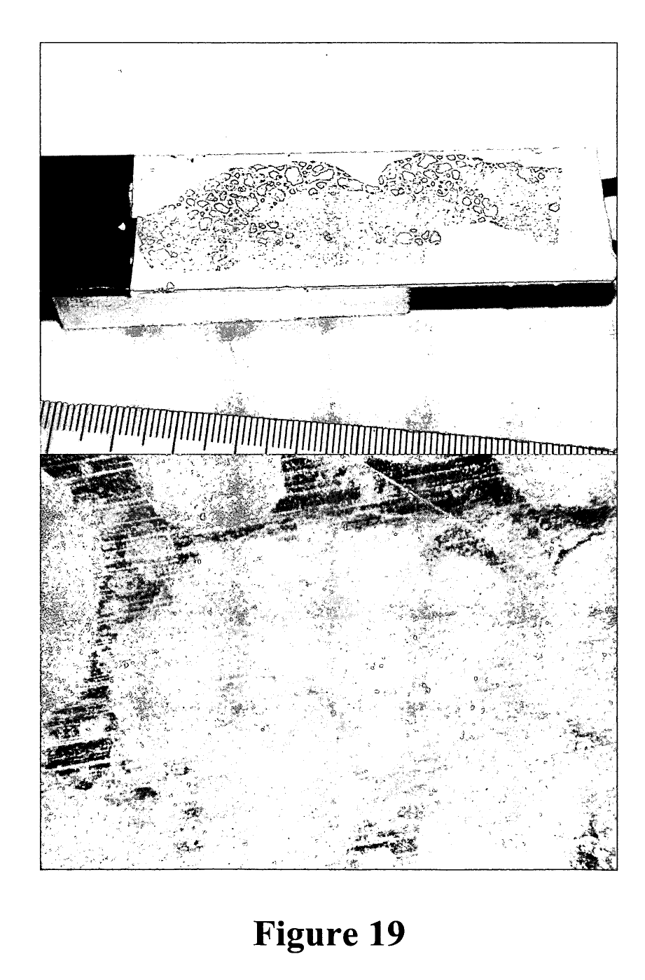

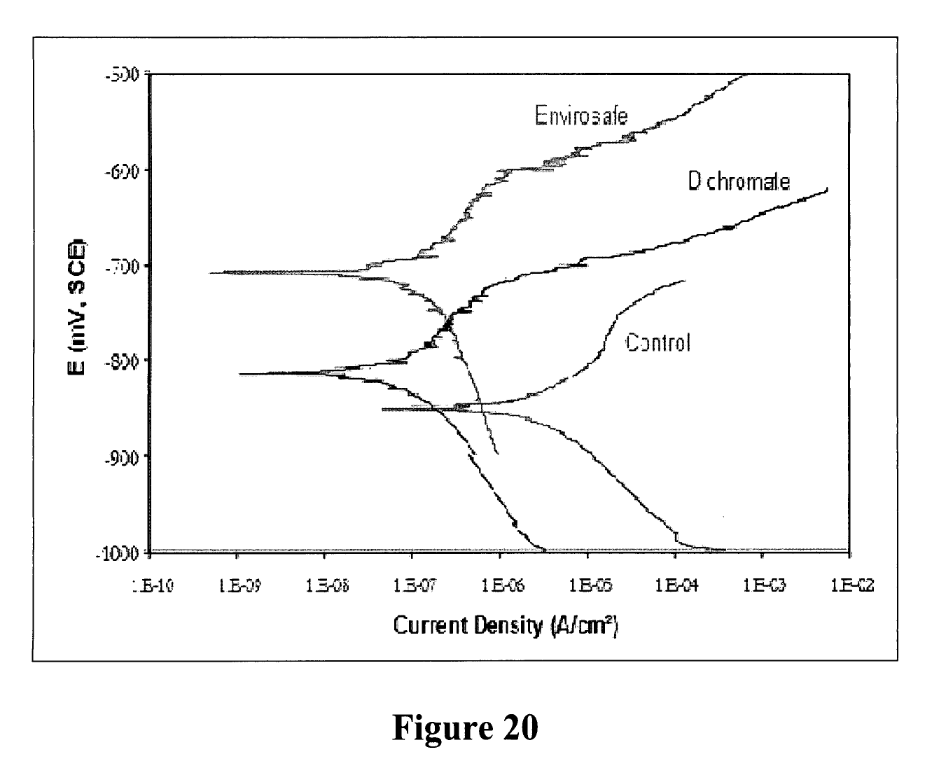

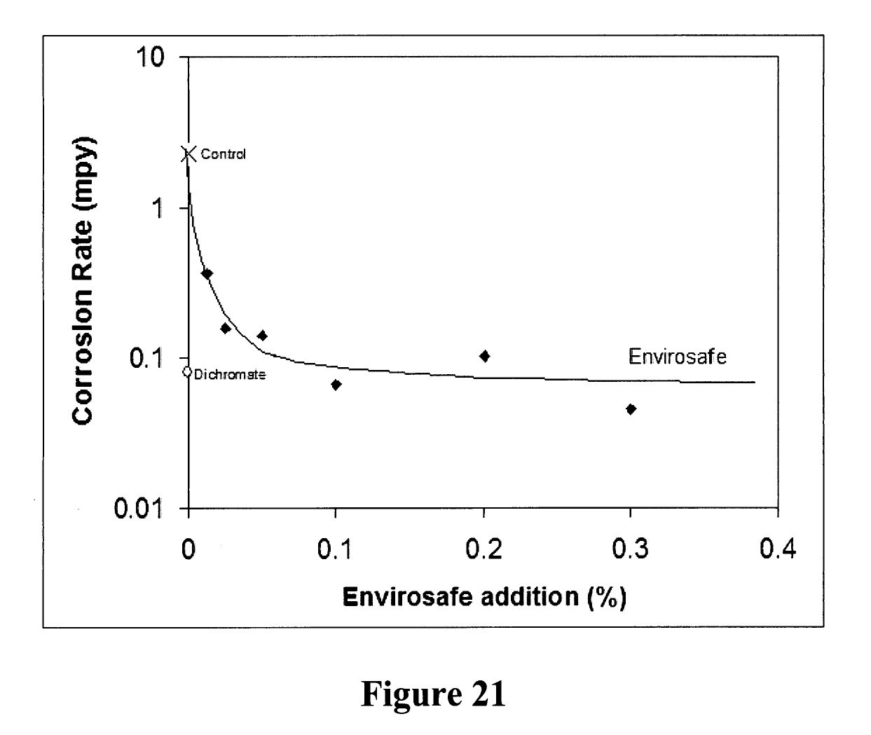

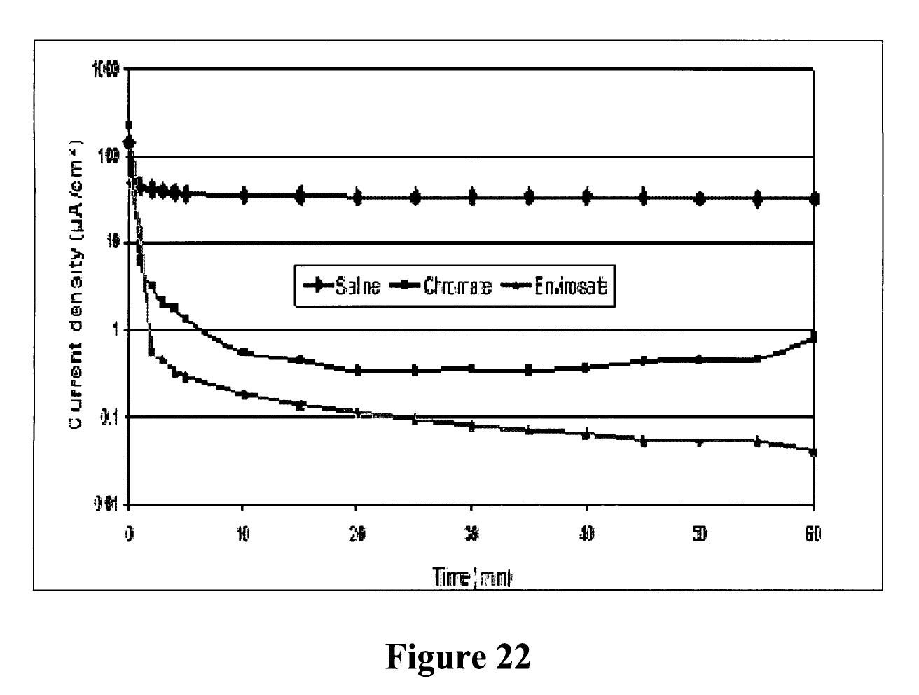

The current data compares favorably to chromate bases anti-corrosives. In particular, as illustrated in FIGS. 19 and 20, the data indicates that the tobacco-based inhibitor system, even at low addition rates, is equal to if not superior to chromates with regard to corrosion inhibition. Additionally, as illustrated in FIGS. 21 and 22, galvanic corrosion studies on the steel-aluminum couple in salt water likewise demonstrate the corrosion inhibiting efficacy of the tobacco-based inhibitor system relative to chromate based anti-corrosives.

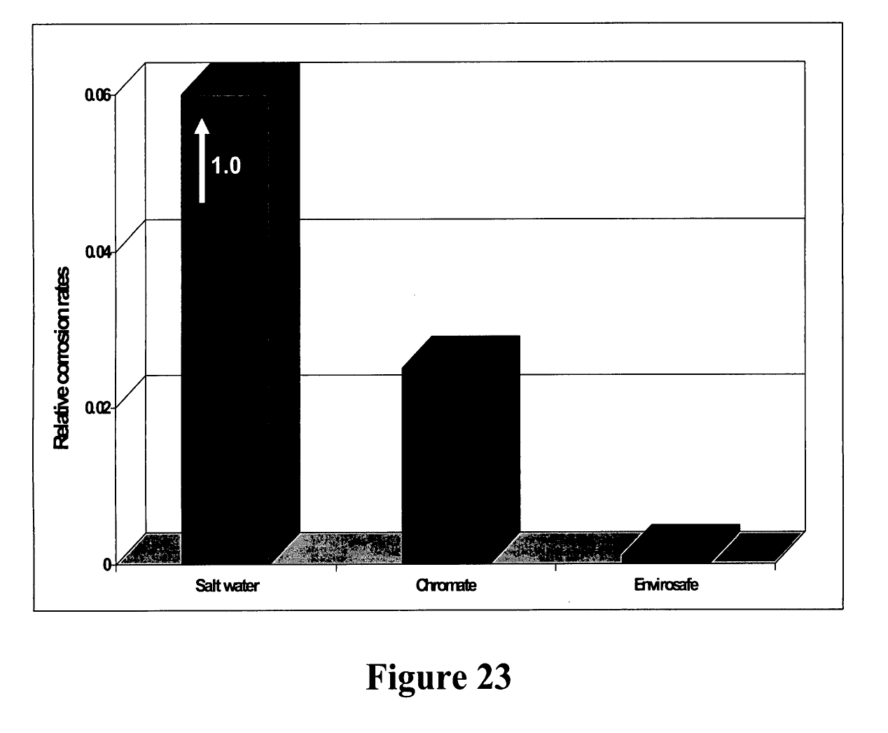

Thus, as shown in FIG. 23, these data show that while chromates are an effective inhibitor for aluminum and steel, the environmentally benign and renewable sourced tobacco-based inhibitor system in fact is more effective with regard to corrosion inhibition.

Pickling and Descaling

As shown in Table 3, the tobacco-based inhibitor products of the invention are very highly effective in stopping acid attack on steel as shown by the markedly lower weight loss of steel in 10% sulfuric acid when the acid contains tobacco extract. Thus, the tobacco-based inhibitor products of the invention are highly effective for removing pickling residues from processed metals.

TABLE 3
Weight loss of mild steel rods in 10% sulfuric acid solution

| | Weight loss in | Weight loss in acid | Protective power |
|---|---|---|---|
| Immersion | untreated acid | containing tobacco | Z (Z = 100 |
| time | (mg/cm²) | (mg/cm²) | for perfect protection) |
| 2.5 hours | 0.82 | 0.01 | 98.8 |
| 24 hours | 64.07 | 0.40 | 99.4 |

Notably, comparable inhibitive effects are achieved when steel is exposed other mineral acids such as hydrochloric and phosphoric acid as well as acetic acid.

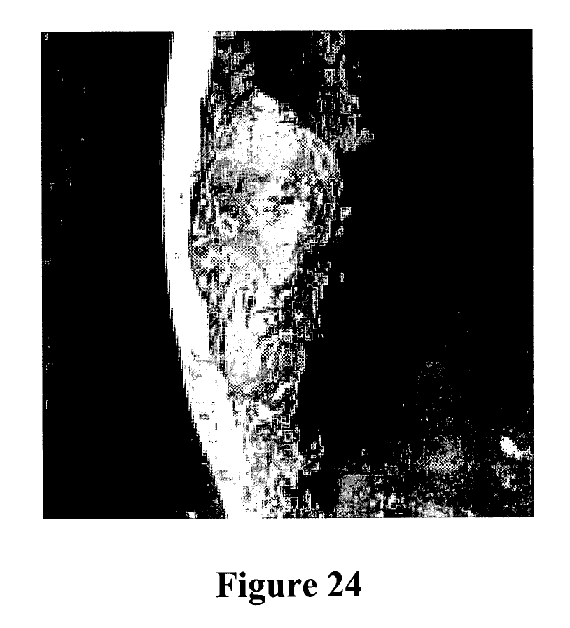

As shown in FIG. 24 hard scale deposits, typically calcium carbonate, silicate, calcium hydrate, calcium sulfate, and iron oxide, inside heat exchanger tubes, piping systems, and water-operated machinery are difficult to remove.

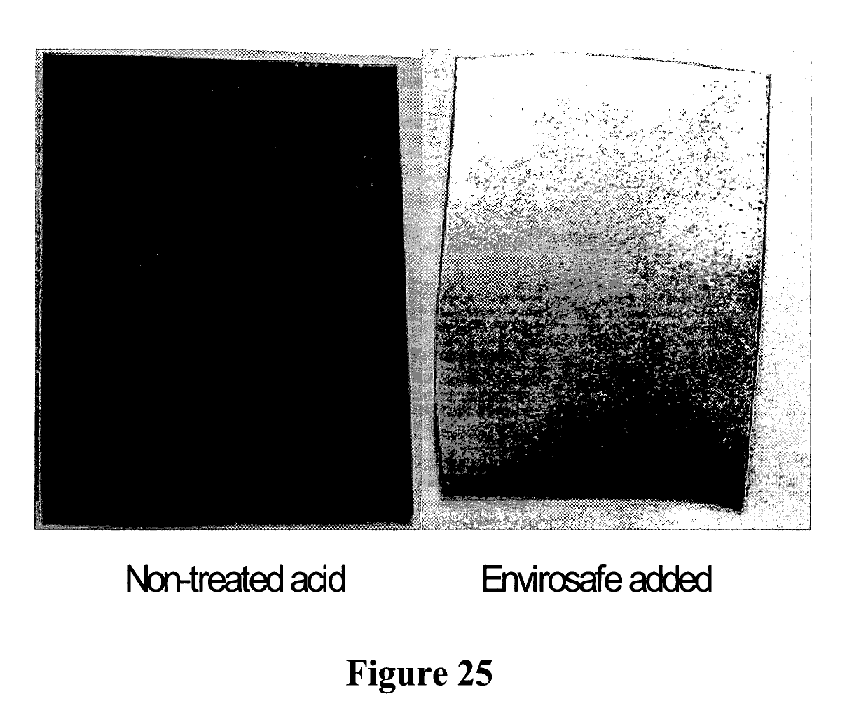

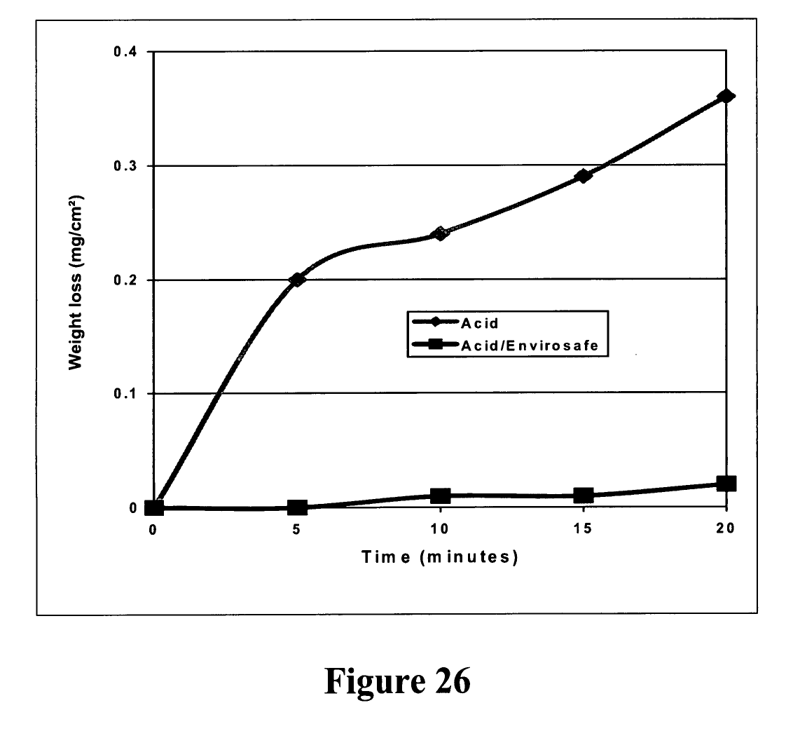

The effectiveness of the tobacco infused products of the invention in preventing corrosion and pitting of steel in sulfuric acid is illustrated in FIGS. 25 and 26 Scrap plant material, remaining after other components of the plant for processing into other consumer products, were digested in 10% H₂SO₄ solution. Steel rods immersed in uninhibited sulfuric acid have a rough, pitted surface with smudge. In contrast, treatment in the inhibited solution results in a clean, shiny surface with almost no weight loss due to dissolved (corroded) metal.

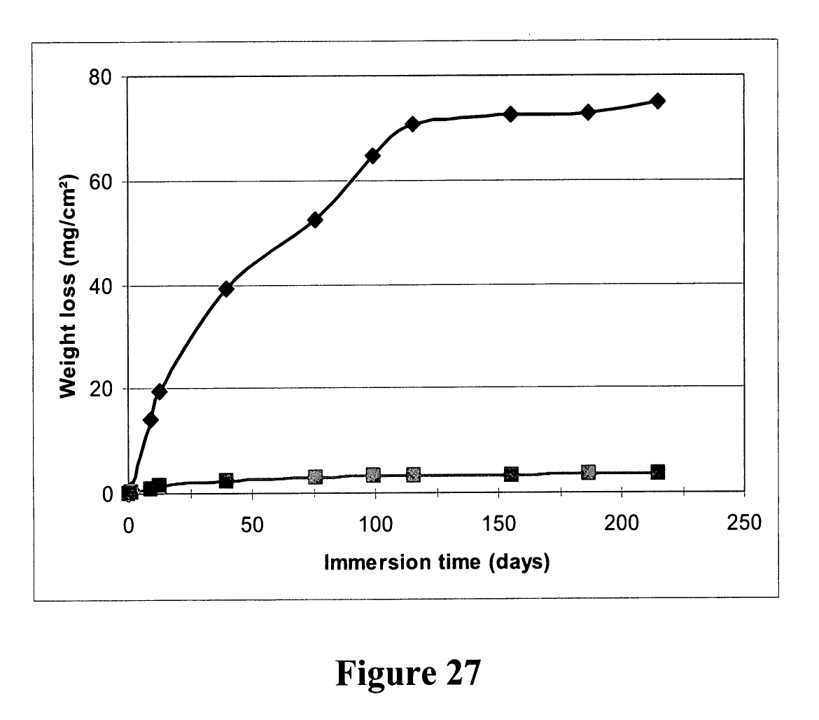

This reduction in the corrosion/dissolution of metal in acids extends to other metals and other acids and is one of the principal advantages of the tobacco infused products of the invention. FIG. 27 how the behavior of steel in solutions of citric acid and hydrochloric acid. The effectiveness of the tobacco infused products of the invention against corrosion is clearly demonstrated.

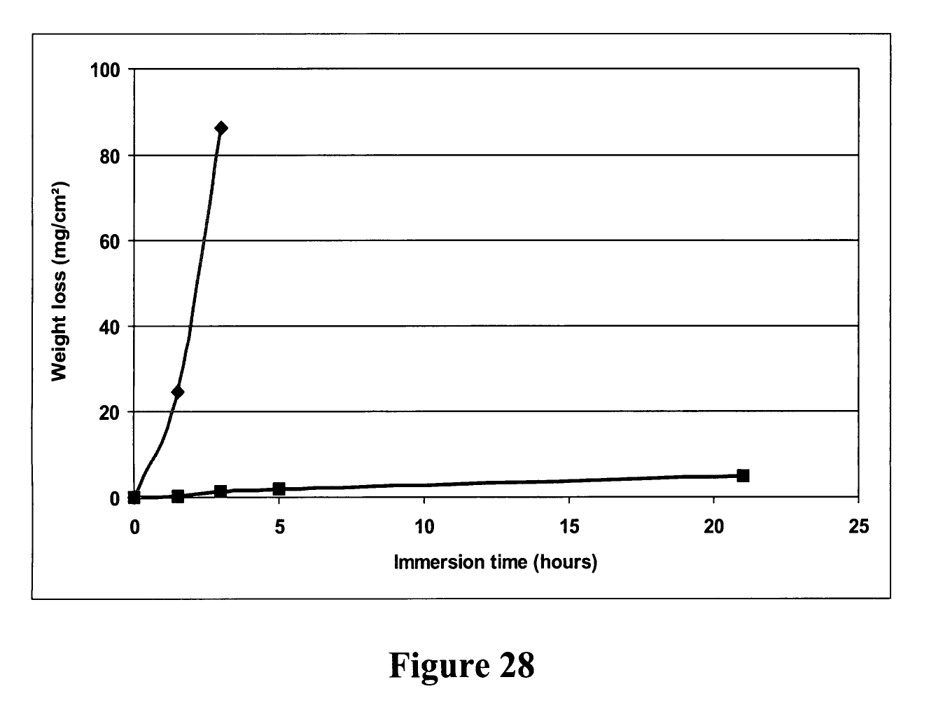

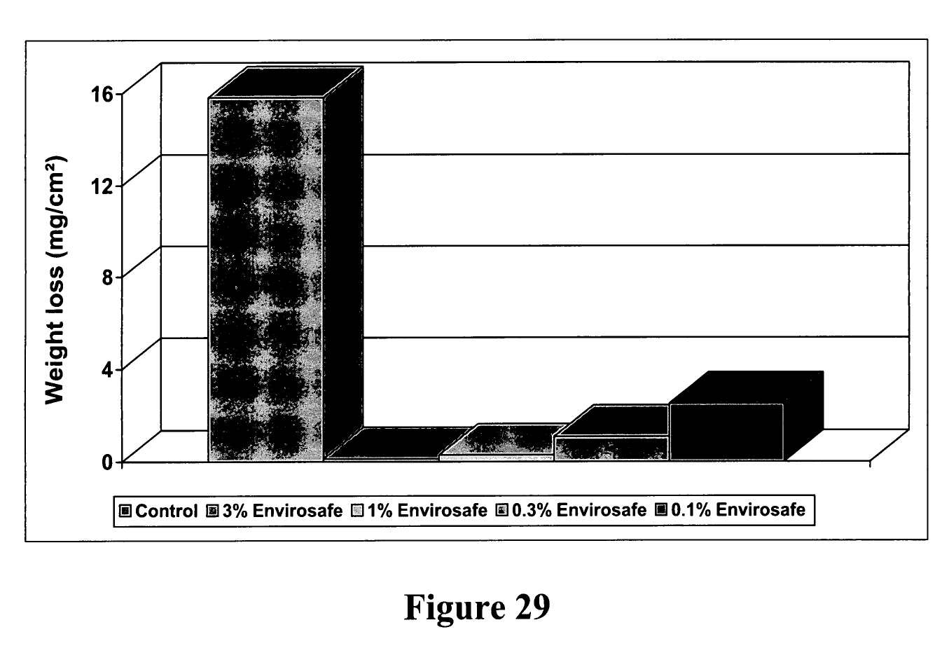

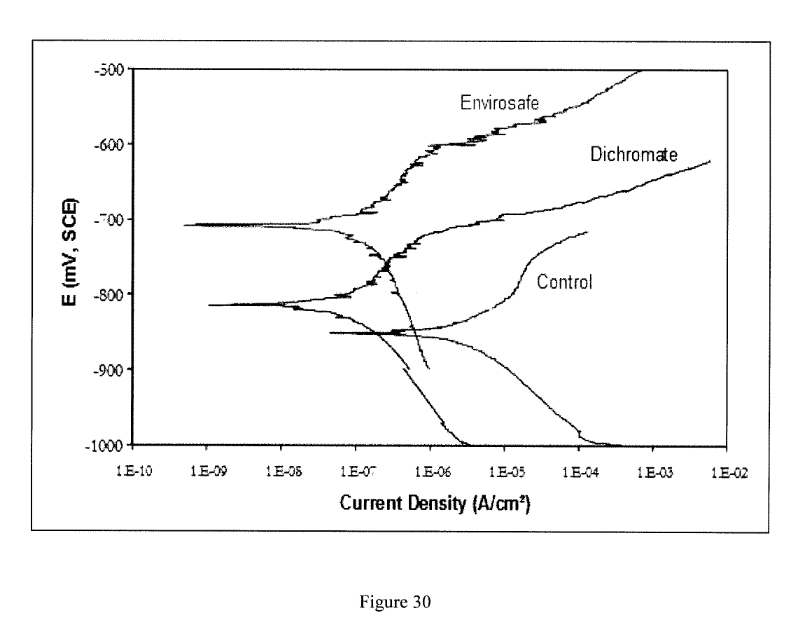

Other experiments showed the effectiveness of the tobacco infused products of the invention in reducing the corrosion of different metals in several acidic and alkaline solutions. In many cases, the acid or alkaline completely dissolved the metal in the uninhibited solution while the coupon remained in the inhibited acid at the end of the experiment. This is very clear from studies on aluminum in sodium hydroxide solution, FIGS. 28 and 29. Aluminum in untreated sodium hydroxide solution completely dissolved within 3 hours while the metal remained virtually unaffected for over 20 hours in the tobacco infused products of the invention-treated alkaline solution.

The objects, features, advantages and ideas of the invention will be apparent to those skilled in the art from the description provided in the specification, and the invention will be readily practicable by those skilled in the art on the basis of the description appearing herein. The Description of the Preferred Embodiments and the Examples which show preferred modes for practicing the invention are included for the purpose of illustration and explanation, and are not intended to limit the scope of the claims. It will be apparent to those skilled in the art that various modifications may be made in how the invention is practiced based on described aspects in the specification without departing from the spirit and scope of the invention disclosed herein.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A corrosion inhibiting coating comprising a tobacco based substance.

2. The corrosion inhibiting coating of claim 1, further comprising at least one organic acid. Inhibition rates of 95% were found for 0.1% tobacco extract additions and 96.6% for 1.0% additions over 55 days.

3. The corrosion inhibiting coating of claim 1, wherein said corrosion inhibiting coating comprises between approximately 0.1% by weight to approximately 10% by weight of said tobacco based substance.

4. The corrosion inhibiting coating of claim 1, wherein said corrosion inhibiting coating comprises between approximately 0.1% by weight and approximately 1.0% by weight of said tobacco based substance.

5. The corrosion inhibiting coating of claim 1, wherein said corrosion inhibiting coating comprises between approximately 1% by weight and approximately 5% by weight of said tobacco based substance.

6. The corrosion inhibiting coating of claim 1, wherein said corrosion inhibiting coating comprises between approximately 5% by weight and approximately 10% by weight of said tobacco based substance.

7. The corrosion inhibiting coating of claim 1, wherein said corrosion inhibiting coating comprises between approximately 0.1% by volume and approximately 50% by volume of said tobacco based substance.

8. The corrosion inhibiting coating of claim 1, wherein said tobacco based substance is in a solid form.

9. The corrosion inhibiting coating of claim 1, wherein said tobacco based substance is in a liquid form.

10. The corrosion inhibiting coating of claim 1, wherein said tobacco based substance comprises at least one of dried tobacco leaves, tobacco stems, tobacco dust, tobacco liquid extract and combinations thereof.

11. The corrosion inhibiting coating of claim 1, wherein said coating is a paint.

12. The corrosion inhibiting coating of claim 11, wherein said paint is an oil-based paint.

13. The corrosion inhibiting coating of claim 11, wherein said paint is a water-based paint.

14. The corrosion inhibiting coating of claim 11, wherein said paint is an exterior grade paint.

15. The corrosion inhibiting coating of claim 11, wherein said paint is an interior grade paint.

16. The corrosion inhibiting coating of claim 1, wherein said coating is a primer.

17. The corrosion inhibiting coating of claim 1, wherein said coating is used to inhibit corrosion on at least one of aluminum, iron, copper, nickel, zinc, alloys thereof and combinations thereof.

18. The corrosion inhibiting coating of claim 17, wherein said coating is used to inhibit corrosion on aluminum.

19. The corrosion inhibiting coating of claim 1, wherein said coating is used to inhibit scaling on at least one metal.

20. The corrosion inhibiting coating of claim 1, wherein said at least one metal is at least one of steel, aluminum, iron, copper, nickel, zinc, alloys thereof and combinations thereof.

21. The corrosion inhibiting coating of claim 20, wherein said at least one metal is steel.

22. A process for inhibiting corrosion of a metal comprising coating said metal with the corrosion inhibiting coating of claim 1.

23. A process for inhibiting scaling of a metal comprising coating said metal with the corrosion inhibiting coating of claim 1.
